(19) United States
(12) Patent Application Publication
(10) Pub. No.: US 2023/0246236 A1
(43) Pub. Date: Aug. 3, 2023

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventor: Kentaro YOSHIMURA, Kyoto (JP)

(21) Appl. No.: 18/133,731

(22) Filed: Apr. 12, 2023

Related U.S. Application Data
(63) Continuation of application No. PCT/JP2021/027139, filed on Jul. 20, 2021.

(30) Foreign Application Priority Data
Oct. 15, 2020 (JP) 2020-173647

(51) Int. Cl. H01M 10/0567; H01M 10/0569; H01M 10/0525

(52) U.S. Cl. CPC H01M 10/0567; H01M 10/0569; H01M 10/0525; H01M 2300/0028

(57) ABSTRACT

A secondary battery includes a positive electrode, a negative electrode, and an electrolytic solution. The electrolytic solution includes a solvent, an electrolyte salt, a first unsaturated compound, and a second unsaturated compound. The first unsaturated compound includes at least one of respective compounds represented by Formulae (1) to (4). The second unsaturated compound includes at least one of respective compounds represented by Formulae (5) to (19).

### CROSS REFERENCE TO RELATED APPLICATIONS

The present application is a continuation of PCT patent application no. PCT/JP2021/027139, filed on Jul. 20, 2021, which claims priority to Japanese patent application no. 2020-173647, filed on Oct. 15, 2020, the entire contents of which are incorporated herein by reference.

### BACKGROUND

The present application relates to an electrolytic solution for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution (an electrolytic solution for a secondary battery). A configuration of the secondary battery has been considered in various ways.

In order to achieve high charging efficiency, an electrolytic solution includes an α-substitutional oxy-γ-butyrolactone derivative. In order to achieve a superior cyclability characteristic, an electrolytic solution includes a cyclic ester having an unsaturated carbon bond in a molecule. In order to suppress an amount of gas generation during continuous charging at a high charge voltage, an electrolytic solution includes lactones each having an unsaturated carbon bond. In order to achieve a favorable high-temperature cyclability characteristic, an electrolytic solution includes an acrylic compound having a cyclic-carbonic-acid-ester-type structure or a lactone-type structure in a molecule. In order to achieve superior durability under a high temperature condition, an electrolytic solution includes an acrylic compound having a lactone-type structure in a molecule.

### SUMMARY

The present application relates to an electrolytic solution for a secondary battery, and a secondary battery.

Although consideration has been given in various ways regarding a battery characteristic of a secondary battery, a cyclability characteristic of the secondary battery is not sufficient yet. Accordingly, there is room for improvement in terms thereof.

It is therefore desirable to provide an electrolytic solution for a secondary battery and a secondary battery each of which makes it possible to achieve a superior cyclability characteristic.

An electrolytic solution for a secondary battery according to an embodiment of the present technology includes a solvent, an electrolyte salt, a first unsaturated compound, and a second unsaturated compound. The first unsaturated compound includes at least one of respective compounds represented by Formulae (1) to (4). The second unsaturated compound includes at least one of respective compounds represented by Formulae (5) to (19).

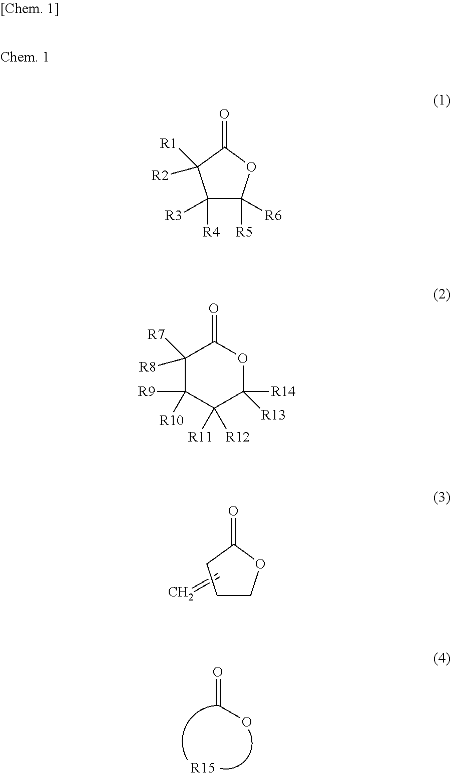

where:
each of R1 to R6 is one of hydrogen (H), an alkyl group, an acrylic acid group, or a methacrylic acid group, and at least one of R1 to R6 is one of the acrylic acid group or the methacrylic acid group;
each of R7 to R14 is one of hydrogen (H), an alkyl group, an acrylic acid group, or a methacrylic acid group, and at least one of R7 to R14 is one of the acrylic acid group or the methacrylic acid group; and
R15 is an alkenylene group.

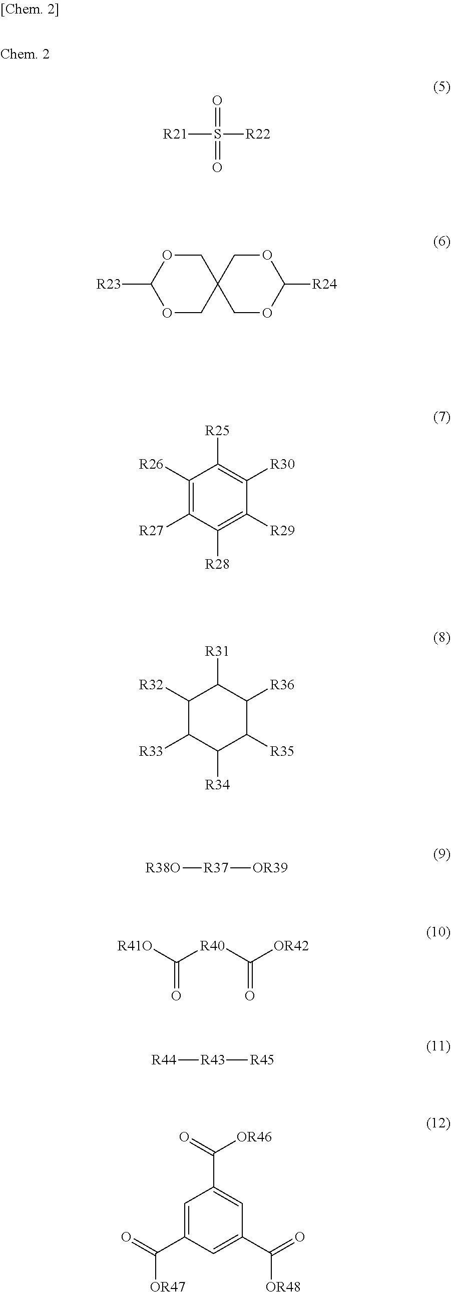

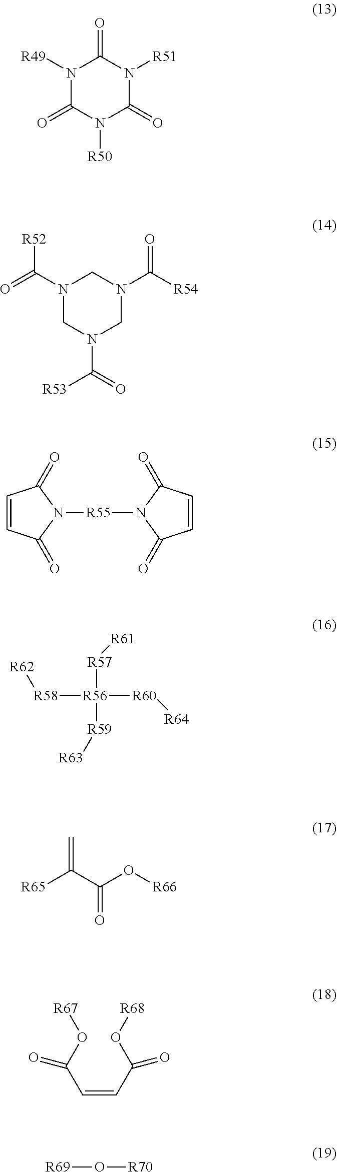

where:
each of R21 and R22 is an alkenyl group;
each of R23 and R24 is an alkenyl group;
each of R25 to R30 is one of hydrogen (H) or an alkenyl group, and two or more of R25 to R30 are each the alkenyl group;
each of R31 to R36 is one of hydrogen (H) or an alkenyl group, and two or more of R31 to R36 are each the alkenyl group;
R37 is an alkylene group having an ether bond;
each of R38 and R39 is an alkenyl group;
R40 is an alkylene group;
each of R41 and R42 is an alkenyl group;
R43 is one of an alkylene group, or an alkylene group having an ether bond;
each of R44 and R45 is one of an acrylic acid group or a methacrylic acid group;
each of R46 to R48 is an alkenyl group;
each of R49 to R51 is one of an alkyl group or an alkenyl group, and two or more of R49 to R51 are each the alkenyl group;
each of R52 to R54 is an alkenyl group;
R55 is one of an alkylene group or an arylene group;
R56 is a tetravalent hydrocarbon group;
each of R57 to R60 is an alkylene group;
each of R61 to R64 is one of a hydroxyl group, an acrylic acid group, or a methacrylic acid group, and two or more of R61 to R64 are each one of the acrylic acid group or the methacrylic acid group;
R65 is one of hydrogen (H) or an alkyl group;
R66 is an alkenyl group;
each of R67 and R68 is an alkenyl group; and
each of R69 and R70 is an alkenyl group.

A secondary battery according to an embodiment of the present technology includes a positive electrode, a negative electrode, and an electrolytic solution. The electrolytic solution has a configuration similar to the configuration of the electrolytic solution for a secondary battery according to an embodiment of the present technology described herein.

Note that further details of each of the “acrylic acid group” and the “methacrylic acid group” will be described herein according to an embodiment.

According to the electrolytic solution for a secondary battery or the secondary battery of an embodiment, the electrolytic solution for a secondary battery includes the first unsaturated compound and the second unsaturated compound. Accordingly, it is possible to achieve a superior cyclability characteristic.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

One or more embodiments of the present technology are described below in further detail including with reference to the drawings.

A description is given of an electrolytic solution for a secondary battery (hereinafter simply referred to as an “electrolytic solution”) according to an embodiment of the present technology.

The electrolytic solution is to be used in a secondary battery. However, the electrolytic solution may be used in an electrochemical unit other than a secondary battery. The electrochemical unit is not particularly limited in kind, and specific examples thereof include a capacitor.

The electrolytic solution includes a solvent, an electrolyte salt, a first unsaturated compound, and a second unsaturated compound. The first unsaturated compound includes one or more of respective compounds represented by Formulae (1) to (4), and the second unsaturated compound includes one or more of respective compounds represented by Formulae (5) to (19).

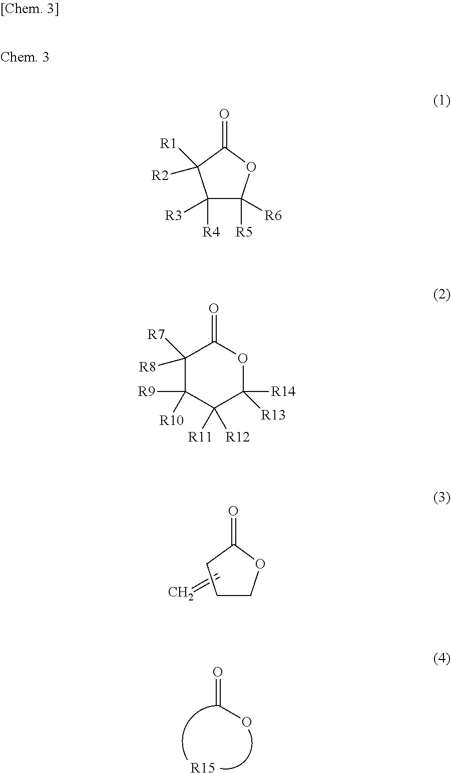

where:
each of R1 to R6 is one of hydrogen (H), an alkyl group, an acrylic acid group, or a methacrylic acid group, and at least one of R1 to R6 is one of the acrylic acid group or the methacrylic acid group;
each of R7 to R14 is one of hydrogen (H), an alkyl group, an acrylic acid group, or a methacrylic acid group, and at least one of R7 to R14 is one of the acrylic acid group or the methacrylic acid group; and
R15 is an alkenylene group.

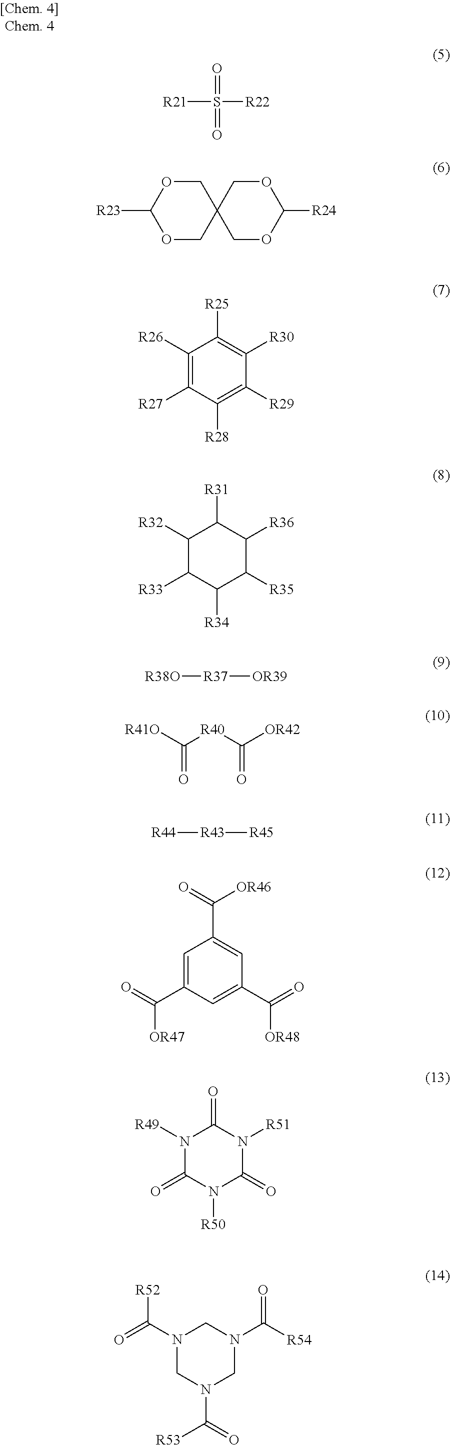

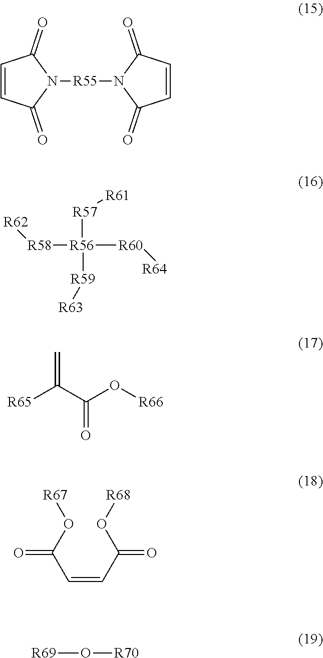

where:
each of R21 and R22 is an alkenyl group;
each of R23 and R24 is an alkenyl group;
each of R25 to R30 is one of hydrogen (H) or an alkenyl group, and two or more of R25 to R30 are each the alkenyl group;
each of R31 to R36 is one of hydrogen (H) or an alkenyl group, and two or more of R31 to R36 are each the alkenyl group;
R37 is an alkylene group having an ether bond;
each of R38 and R39 is an alkenyl group;
R40 is an alkylene group;
each of R41 and R42 is an alkenyl group;
R43 is one of an alkylene group, or an alkylene group having an ether bond;
each of R44 and R45 is one of an acrylic acid group or a methacrylic acid group;
each of R46 to R48 is an alkenyl group;
each of R49 to R51 is one of an alkyl group or an alkenyl group, and two or more of R49 to R51 are each the alkenyl group;
each of R52 to R54 is an alkenyl group;
R55 is one of an alkylene group or an arylene group;
R56 is a tetravalent hydrocarbon group;
each of R57 to R60 is an alkylene group;
each of R61 to R64 is one of a hydroxyl group, an acrylic acid group, or a methacrylic acid group, and two or more of R61 to R64 are each one of the acrylic acid group or the methacrylic acid group;
R65 is one of hydrogen (H) or an alkyl group;
R66 is an alkenyl group;
each of R67 and R68 is an alkenyl group; and
each of R69 and R70 is an alkenyl group.

A reason why the electrolytic solution includes both the first unsaturated compound and the second unsaturated compound is that this improves, as compared with a case where the electrolytic solution includes only one of the first unsaturated compound or the second unsaturated compound, durability of a film formed on a surface of an electrode in a case where the electrolytic solution is included in the secondary battery. The “electrode” is a positive electrode 21, a negative electrode 22, or both. The positive electrode 21 and the negative electrode 22 are to be described later. A decomposition reaction of the electrolytic solution on the surface of the electrode is thereby suppressed upon charging and discharging, and this prevents a discharge capacity from decreasing easily even upon repeated charging and discharging. Details of the reason described here are to be described later.

As represented by each of Formulae (1) to (4), the first unsaturated compound is a cyclic compound having a lactone-type ring structure and having an unsaturated carbon bond (a carbon-carbon double bond).

The unsaturated carbon bond may be present at an inside of the lactone-type ring structure, may be present at an outside of the lactone-type ring structure, or may be present at each of the inside and the outside. The number of unsaturated carbon bonds may be one, or two or more.

The lactone-type ring structure is a carbon ring structure having —C(═O)—O— as a portion of the ring, and the number of carbon atoms that form a ring with —C(═O)—O— is not particularly limited. For this reason, the lactone-type ring structure may be a five-membered ring, a six-membered ring, or another ring.

Hereinafter, the compound represented by Formula (1) is referred to as a “first unsaturated compound A”, the compound represented by Formula (2) is referred to as a “first unsaturated compound B”, the compound represented by Formula (3) is referred to as a “first unsaturated compound C”, and the compound represented by Formula (4) is referred to as a “first unsaturated compound D”.

As represented by Formula (1), the first unsaturated compound A is a cyclic compound having the lactone-type ring structure which is the five-membered ring and having the unsaturated carbon bond outside the lactone-type ring structure.

Each of R1 to R6 is not particularly limited as long as each of R1 to R6 is one of hydrogen (H), an alkyl group, an acrylic acid group, or a methacrylic acid group; however, one or more of R1 to R6 are each one of the acrylic acid group or the methacrylic acid group. A reason for this is that, as described above, the first unsaturated compound A has to have the unsaturated carbon bond. Accordingly, a compound in which each of R1 to R6 is one of hydrogen (H) or the alkyl group has no unsaturated carbon bond, and is thus excluded from the first unsaturated compound A.

Carbon number of the alkyl group is not particularly limited. The alkyl group may have: a straight-chain structure; or a branched structure having one or more side chains. Specific examples of the alkyl group include a methyl group, an ethyl group, a propyl group, and a butyl group.

The acrylic acid group is a group represented by —O—C(═O)—CH═CH₂. In other words, the acrylic acid group is a group in which a hydrogen atom at a terminal (i.e., a hydrogen atom bonded to an oxygen atom) of an acrylic acid (CH₂═CH—C(═O)—OH) is removed.

The methacrylic acid group is a group represented by —O—C(═O)—C(—CH₃)═CH₂. In other words, the methacrylic acid group is a group in which a hydrogen atom at a terminal of a methacrylic acid (CH₂═C(—CH₃)—C(═O)—OH) is removed.

As represented by Formula (2), the first unsaturated compound B is a cyclic compound having the lactone-type ring structure which is the six-membered ring and having the unsaturated carbon bond outside the lactone-type ring structure.

Each of R7 to R14 is not particularly limited as long as each of R7 to R14 is one of hydrogen (H), an alkyl group, an acrylic acid group, or a methacrylic acid group; however, one or more of R7 to R14 are each one of the acrylic acid group or the methacrylic acid group. A reason for this is that, as described above, the first unsaturated compound B has to have the unsaturated carbon bond. Accordingly, a compound in which each of R7 to R14 is one of hydrogen (H) or the alkyl group has no unsaturated carbon bond, and is thus excluded from the first unsaturated compound B. Details of each of the alkyl group, the acrylic acid group, and the methacrylic acid group are as described above.

As represented by Formula (3), the first unsaturated compound C is a cyclic compound having the lactone-type ring structure which is the five-membered ring and having the unsaturated carbon bond outside the lactone-type ring structure.

The first unsaturated compound C has one methylene group (CH₂═CH—) having the unsaturated carbon bond. In other words, Formula (3) indicates that the methylene group is bonded to one of three carbon (C) atoms that form the lactone-type ring structure (the five-membered ring) together with —C(═O)—O—. Accordingly, the methylene group is bonded to one of a carbon atom at the α-position, a carbon atom at the β-position, or a carbon atom at the γ-position.

As represented by Formula (4), the first unsaturated compound D is a cyclic compound having the lactone-type ring structure and having the unsaturated carbon bond inside the lactone-type ring structure.

R15 is not particularly limited as long as R15 is an alkenylene group. In this case, carbon number of the alkenylene group is not particularly limited. Accordingly, the shape of the lactone-type structure (i.e., the number of members in the ring) is determined depending on carbon number of the alkenylene group. The alkenylene group may have a straight-chain structure or a branched structure.

Specific examples of the straight-chain alkenylene group include —CH═CH—, —CH═CH—CH₂—, —CH₂—CH═CH—, —CH═CH—CH₂—CH₂—, —CH₂—CH₂—CH═CH—, and —CH═CH—CH═CH—.

Specific examples of the branched alkenylene group include —C(—CH₃)═CH—CH₂—, —CH═C(—CH₃)—CH₂—, —CH₂—CH₂—C(—CH₃)═CH—, —CH₂—CH₂—CH═C(—CH₃)—, —C(—CH₃)═CH—CH₂—CH₂—, —CH═C(—CH₃)—CH₂—CH₂—, —CH₂—CH₂—C(—CH₃)═CH—, —CH₂—CH₂—CH═C(—CH₃)—, —C(—CH₃)═CH—CH═CH—, —CH═C(—CH₃)—CH═CH—, —CH═CH—C(—CH₃)═CH—, and —CH═CH—CH═C(—CH₃)—.

In particular, the first unsaturated compound D preferably includes one or more of respective compounds represented by Formulae (21) to (24). A reason for this is that this sufficiently improves the durability of the film formed on the surface of the electrode.

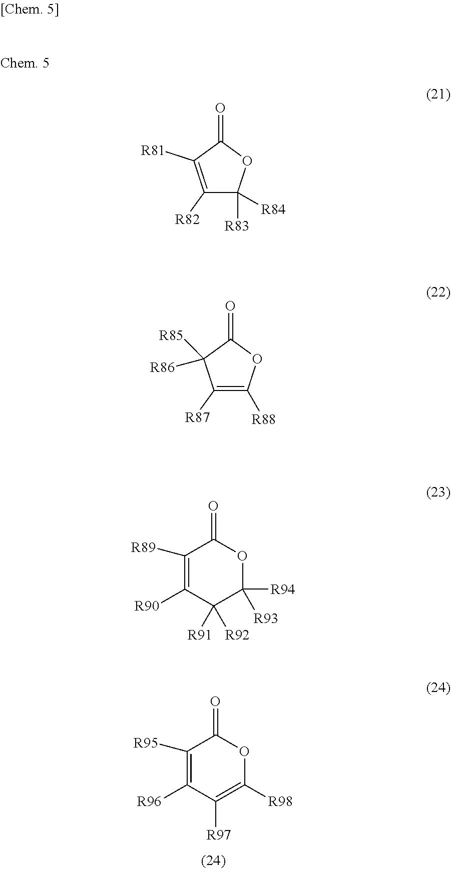

where
each of R81 to R98 is one of hydrogen (H) or an alkyl group.

The respective compounds represented by Formulae (21) and (22) each have the lactone-type ring structure which is the five-membered ring and have one unsaturated carbon bond inside the lactone-type ring structure. However, the compound represented by Formula (21) and the compound represented by Formula (22) are different from each other in position of the unsaturated carbon bond.

The compound represented by Formula (23) has the lactone-type ring structure which is the six-membered ring and has one unsaturated carbon bond inside the lactone-type ring structure.

The compound represented by Formula (24) has the lactone-type ring structure which is the six-membered ring and has two unsaturated carbon bonds inside the lactone-type ring structure.

Each of R81 to R98 is not particularly limited as long as each of R81 to R98 is one of hydrogen (H) or an alkyl group. Details of the alkyl group are as described above.

Specific examples of the first unsaturated compound A include respective compounds represented by Formulae (1-1) to (1-4). Specific examples of the first unsaturated compound B include a compound represented by Formula (2-1). Specific examples of the first unsaturated compound C include respective compounds represented by Formulae (3-1) and (3-2). Specific examples of the first unsaturated compound D include respective compounds represented by Formulae (4-1) to (4-6).

Here, the respective compounds represented by Formulae (4-1) to (4-3) each correspond to the compound represented by Formula (21). The compound represented by Formula (4-4) corresponds to the compound represented by Formula (22). The compound represented by Formula (4-5) corresponds to the compound represented by Formula (23). The compound represented by Formula (4-6) corresponds to the compound represented by Formula (24).

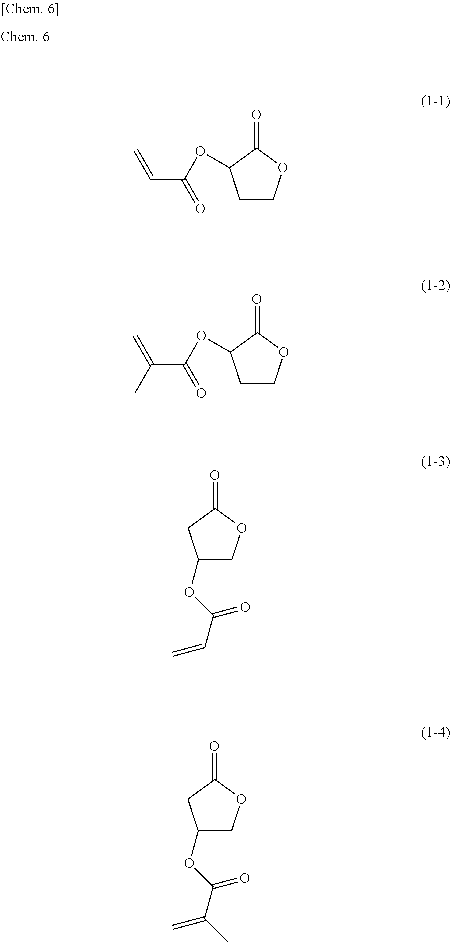

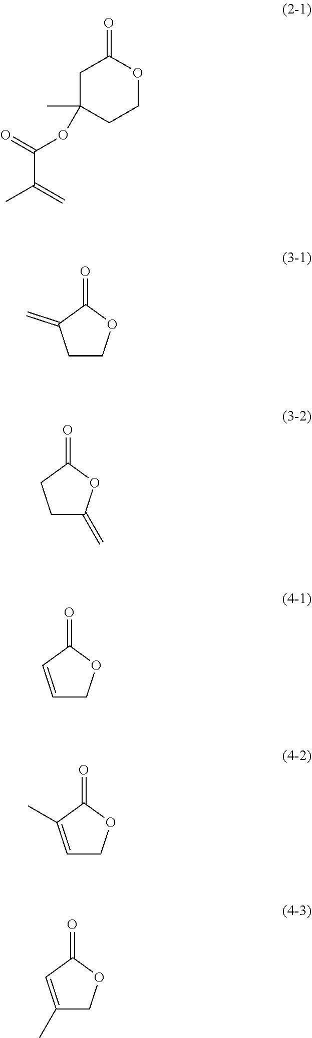

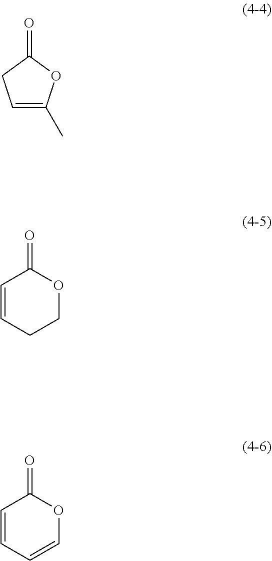

More specifically, the compound represented by Formula (1-1) is acrylic acid 2-oxotetrahydrofuran-3-yl. The compound represented by Formula (1-2) is methacrylic acid 2-oxotetrahydrofuran-3-yl. The compound represented by Formula (1-3) is acrylic acid 5-oxotetrahydrofuran-3-yl. The compound represented by Formula (1-4) is methacrylic acid 5-oxotetrahydrofuran-3-yl.

The compound represented by Formula (2-1) is methacrylic acid 4-methyl-2-oxotetrahydro-2H-pyran-4-yl.

The compound represented by Formula (3-1) is α-methylene-γ-butyrolactone. The compound represented by Formula (3-2) is γ-methylene-γ-butyrolactone.

The compound represented by Formula (4-1) is γ-crotonolactone. The compound represented by Formula (4-2) is 3-methyl-2(5H)-furanone. The compound represented by Formula (4-3) is 4-methyl-2(5H)-furanone. The compound represented by Formula (4-4) is α-angelicalactone. The compound represented by Formula (4-5) is 5,6-dihydro-2H-pyran-2-one. The compound represented by Formula (4-6) is α-pyrone.

A content of the first unsaturated compound in the electrolytic solution is not particularly limited, and in particular, the content is preferably within a range from 0.1 wt % to 2 wt % both inclusive. A reason for this is that this sufficiently improves the durability of the film. The content described here is, in a case where the electrolytic solution includes two or more first unsaturated compounds, a sum total of contents of the respective first unsaturated compounds.

As represented by each of Formulae (5) to (19), the second unsaturated compound is a chain or cyclic compound having no lactone-type ring structure and having the unsaturated carbon bond (the carbon-carbon double bond).

Hereinafter, the compound represented by Formula (5) is referred to as a “second unsaturated compound A”, the compound represented by Formula (6) is referred to as a “second unsaturated compound B”, the compound represented by Formula (7) is referred to as a “second unsaturated compound C”, the compound represented by Formula (8) is referred to as a “second unsaturated compound D”, the compound represented by Formula (9) is referred to as a “second unsaturated compound E”, the compound represented by Formula (10) is referred to as a “second unsaturated compound F”, the compound represented by Formula (11) is referred to as a “second unsaturated compound G”, the compound represented by Formula (12) is referred to as a “second unsaturated compound H”, the compound represented by Formula (13) is referred to as a “second unsaturated compound I”, the compound represented by Formula (14) is referred to as a “second unsaturated compound J”, the compound represented by Formula (15) is referred to as a “second unsaturated compound K”, the compound represented by Formula (16) is referred to as a “second unsaturated compound L”, the compound represented by Formula (17) is referred to as a “second unsaturated compound M”, the compound represented by Formula (18) is referred to as a “second unsaturated compound N”, and the compound represented by Formula (19) is referred to as a “second unsaturated compound O”.

As represented by Formula (5), the second unsaturated compound A is a chain compound having a sulfonyl group (—S(═O)₂—) and having the unsaturated carbon bond.

Each of R21 and R22 is not particularly limited as long as each of R21 and R22 is an alkenyl group. Carbon number of the alkenyl group is not particularly limited. The alkenyl group may have a straight-chain structure or a branched structure. The alkenyl group is not particularly limited in kind, and specific examples thereof include a vinyl group and an allyl group.

As represented by Formula (6), the second unsaturated compound B is a cyclic compound having a spirobi(m-dioxane)-type ring structure and having the unsaturated carbon bond.

Each of R23 and R24 is not particularly limited as long as each of R23 and R24 is an alkenyl group. Details of the alkenyl group are as described above.

As represented by Formula (7), the second unsaturated compound C is a cyclic compound having a benzene-type ring structure and having the unsaturated carbon bond.

Each of R25 to R30 is not particularly limited as long as each of R25 to R30 is one of hydrogen (H) or an alkenyl group; however, two or more of R25 to R30 are each the alkenyl group. Details of the alkenyl group are as described above.

As represented by Formula (8), the second unsaturated compound D is a cyclic compound having a cyclohexane-type ring structure and having the unsaturated carbon bond.

Each of R31 to R36 is not particularly limited as long as each of R31 to R36 is one of hydrogen (H) or an alkenyl group; however, two or more of R31 to R36 are each the alkenyl group. A reason for this is that, as described above, the second unsaturated compound D has to have the unsaturated carbon bond. Accordingly, a compound in which each of R31 to R36 is hydrogen (H) has no unsaturated carbon bond, and is thus excluded from the second unsaturated compound D. Details of the alkenyl group are as described above.

As represented by Formula (9), the second unsaturated compound E is a chain compound having a diethylene-glycol-type structure and having the unsaturated carbon bond.

R37 is not particularly limited as long as R37 is an alkylene group having an ether bond (—O—). The alkylene group having an ether bond is a chain group in which one or more ether bonds are introduced in the middle of the alkylene group.

Carbon number of the alkylene group is not particularly limited. The alkylene group may have a straight-chain structure or a branched structure. Specific examples of the alkylene group include a methylene group, an ethylene group, a propylene group, and a butylene group. Accordingly, specific examples of the alkylene group having an ether bond include —CH₂—O—CH₂—, —CH₂—O—CH₂—CH₂—, —CH₂—CH₂—O—CH₂—, and —CH₂—CH₂—O—CH₂—CH₂—.

Each of R38 and R39 is not particularly limited as long as each of R38 and R39 is an alkenyl group. Details of the alkenyl group are as described above.

As represented by Formula (10), the second unsaturated compound F is a chain compound having an adipic-acid-type structure and having the unsaturated carbon bond.

R40 is not particularly limited as long as R40 is an alkylene group. Details of the alkylene group are as described above. Each of R41 and R42 is not particularly limited as long as each of R41 and R42 is an alkenyl group. Details of the alkenyl group are as described above.

As represented by Formula (11), the second unsaturated compound G is a chain compound having a polyethylene-glycol-type structure and having the unsaturated carbon bond.

R43 is not particularly limited as long as R43 is one of an alkylene group, or an alkylene group having an ether bond. Details of the alkylene group and details of the alkylene group having an ether bond are as described above. Each of R44 and R45 is not particularly limited as long as each of R44 and R45 is one of an acrylic acid group or a methacrylic acid group. Details of each of the acrylic acid group and the methacrylic acid group are as described above.

As represented by Formula (12), the second unsaturated compound H is a cyclic compound having a trimesic-acid-type structure and having the unsaturated carbon bond.

Each of R46 to R48 is not particularly limited as long as each of R46 to R48 is an alkenyl group. Details of the alkenyl group are as described above.

As represented by Formula (13), the second unsaturated compound I is a cyclic compound having an isocyanuric-acid-type structure and having the unsaturated carbon bond.

Each of R49 to R51 is not particularly limited as long as each of R49 to R51 is one of an alkyl group or an alkenyl group; however, two or more of R49 to R51 are each the alkenyl group. A reason for this is that, as described above, the second unsaturated compound I has to have the unsaturated carbon bond. Accordingly, a compound in which each of R49 to R51 is the alkyl group has no unsaturated carbon bond, and is thus excluded from the second unsaturated compound I. Details of each of the alkyl group and the alkenyl group are as described above.

As represented by Formula (14), the second unsaturated compound J is a cyclic compound having a triazine-type structure and having the unsaturated carbon bond.

Each of R52 to R54 is not particularly limited as long as each of R52 to R54 is an alkenyl group. Details of the alkenyl group are as described above.

As represented by Formula (15), the second unsaturated compound K is a cyclic compound having a dimaleimide-type structure and having the unsaturated carbon bond.

R55 is not particularly limited as long as R55 is one of an alkylene group or an arylene group. Details of the alkylene group are as described above. Specific examples of the alkylene group include an ethylene group, a propylene group, and a butylene group. Specific examples of the arylene group include a phenylene group and a naphthylene group.

As represented by Formula (16), the second unsaturated compound L is a cyclic compound having a pentaerythritol-type structure and having the unsaturated carbon bond.

R56 is not particularly limited as long as R56 is a tetravalent hydrocarbon group. The tetravalent hydrocarbon group is a group in which four hydrogen atoms are removed from each of an alkane, an alkene, an alkyne, a cycloalkane, and an aromatic hydrocarbon. Specific examples of the alkane include a butane and a pentane. Specific examples of the alkene include butene and pentene. Specific examples of the alkyne include butyne and pentyne. Specific examples of the cycloalkane include cyclobutane, cyclopentane, and cyclohexane. Specific examples of the aromatic hydrocarbon include benzene and naphthalene.

Each of R57 to R60 is not particularly limited as long as each of R57 to R60 is an alkylene group. Details of the alkylene group are as described above.

Each of R61 to R64 is not particularly limited as long as each of R61 to R64 is one of a hydroxyl group, an acrylic acid group, or a methacrylic acid group; however, two or more of R61 to R64 are each one of the acrylic acid group or the methacrylic acid group. Details of each of the acrylic acid group and the methacrylic acid group are as described above.

As represented by Formula (17), the second unsaturated compound M is a chain compound having an acrylic-acid-type structure and having the unsaturated carbon bond.

R65 is not particularly limited as long as R65 is one of hydrogen (H) or an alkyl group. Details of the alkyl group are as described above. R66 is not particularly limited as long as R66 is an alkenyl group. Details of the alkenyl group are as described above.

As represented by Formula (18), the second unsaturated compound N is a chain compound having a maleic-acid-type structure and having the unsaturated carbon bond.

Each of R67 and R68 is not particularly limited as long as each of R67 and R68 is an alkenyl group. Details of the alkenyl group are as described above.

As represented by Formula (19), the second unsaturated compound O is a chain compound having an ether bond and having the unsaturated carbon bond.

Each of R69 and R70 is not particularly limited as long as each of R69 and R70 is an alkenyl group. Details of the alkenyl group are as described above.

Specific examples of the second unsaturated compound A include a compound represented by Formula (5-1). Specific examples of the second unsaturated compound B include a compound represented by Formula (6-1). Specific examples of the second unsaturated compound C include respective compounds represented by Formulae (7-1) and (7-2). Specific examples of the second unsaturated compound D include a compound represented by Formula (8-1).

Specific examples of the second unsaturated compound E include a compound represented by Formula (9-1). Specific examples of the second unsaturated compound F include a compound represented by Formula (10-1). Specific examples of the second unsaturated compound G include respective compounds represented by Formulae (11-1) to (11-3). Specific examples of the second unsaturated compound H include a compound represented by Formula (12-1).

Specific examples of the second unsaturated compound I include a compound represented by Formula (13-1). Specific examples of the second unsaturated compound J include a compound represented by Formula (14-1). Specific examples of the second unsaturated compound K include respective compounds represented by Formulae (15-1) to (15-3). Specific examples of the second unsaturated compound L include respective compounds represented by Formulae (16-1) and (16-2).

Specific examples of the second unsaturated compound M include respective compounds represented by Formulae (17-1) and (17-2). Specific examples of the second unsaturated compound N include a compound represented by Formula (18-1). Specific examples of the second unsaturated compound O include a compound represented by Formula (19-1).

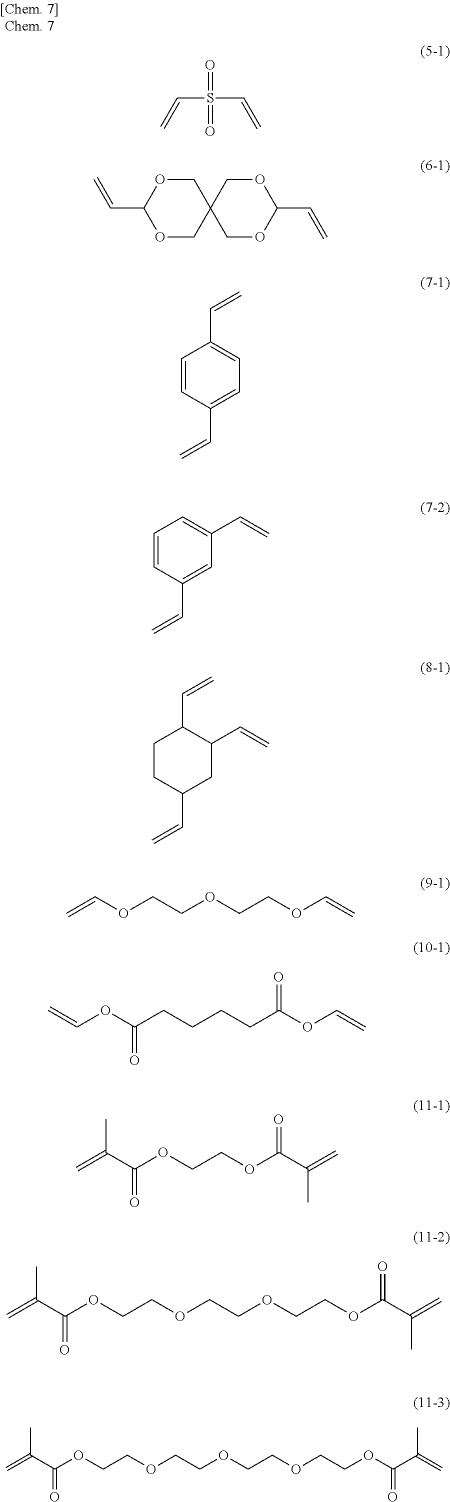

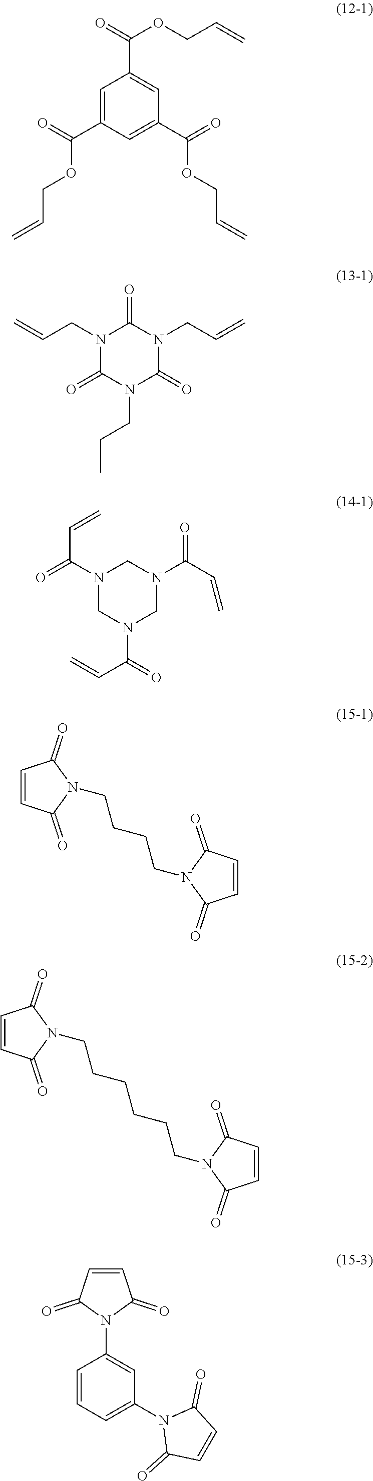

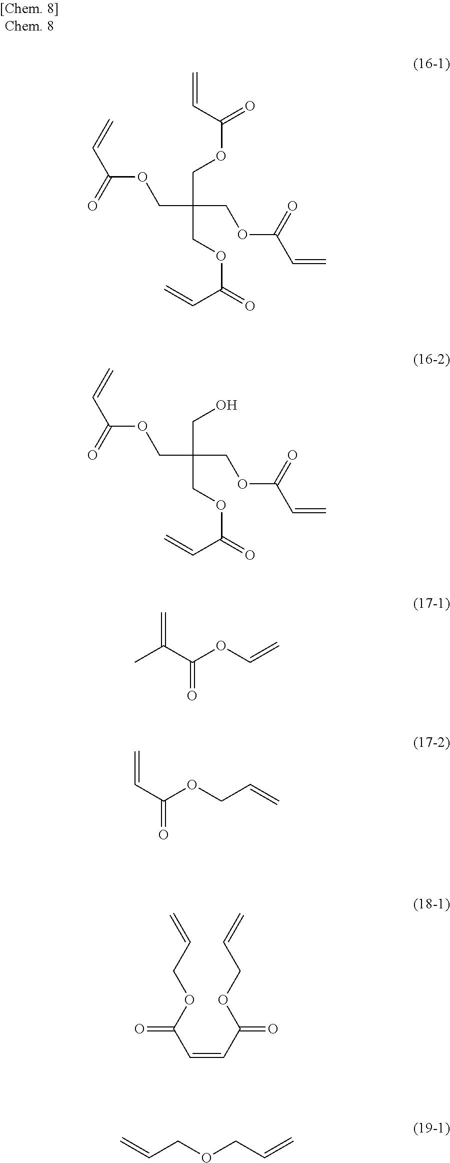

More specifically, the compound represented by Formula (5-1) is divinylsulfone.

The compound represented by Formula (6-1) is 3,9-divinylspirobi(m-dioxane).

The compound represented by Formula (7-1) is p-divinylbenzene. The compound represented by Formula (7-2) is m-divinylbenzene.

The compound represented by Formula (8-1) is 1,2,4-trivinylcyclohexane.

The compound represented by Formula (9-1) is diethylene glycol divinyl ether.

The compound represented by Formula (10-1) is adipic acid divinyl.

The compound represented by Formula (11-1) is ethylene glycol dimethacrylate. The compound represented by Formula (11-2) is triethylene glycol dimethacrylate. The compound represented by Formula (11-3) is tetraethylene glycol dimethacrylate.

The compound represented by Formula (12-1) is trimesic acid triallyl.

The compound represented by Formula (13-1) is isocyanuric acid diallyl propyl.

The compound represented by Formula (14-1) is 1,3,5-triacryloylhexahydro-1,3,5-triazine.

The compound represented by Formula (15-1) is 1,4-bis(maleimide)butane. The compound represented by Formula (15-2) is 1,6-bis(maleimide)hexane. The compound represented by Formula (15-3) is N,N-1,3-phenylene dimaleimide.

The compound represented by Formula (16-1) is pentaerythritol tetraacrylate. The compound represented by Formula (16-2) is pentaerythritol triacrylate.

The compound represented by Formula (17-1) is vinyl methacrylate. The compound represented by Formula (17-2) is allyl acrylate.

The compound represented by Formula (18-1) is maleic acid diallyl.

The compound represented by Formula (19-1) is diallyl ether.

A content of the second unsaturated compound in the electrolytic solution is not particularly limited, and in particular, the content is preferably within a range from 0.01 wt % to 1 wt % both inclusive. A reason for this is that this sufficiently improves the durability of the film. The content described here is, in a case where the electrolytic solution includes two or more second unsaturated compounds, a sum total of contents of the respective second unsaturated compounds.

The solvent includes one or more of non-aqueous solvents (organic solvents), and the electrolytic solution including the non-aqueous solvent(s) is a so-called non-aqueous electrolytic solution. The non-aqueous solvent is, for example, an ester or an ether, more specifically, a carbonic-acid-ester-based compound, a carboxylic-acid-ester-based compound, or a lactone-based compound, for example.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, methyl propionate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, the lactone-based compound described above, 1,2-dimethoxyethane, tetrahydrofuran, 1,3-dioxolane, or 1,4-dioxane.

It is preferable that the non-aqueous solvent include a high-dielectric-constant solvent having a specific dielectric constant of greater than or equal to 20 at a temperature within a range of higher than or equal to −30° C. and lower than 60° C. A reason for this is that a high battery capacity is obtainable in the case where the electrolytic solution is included in the secondary battery. The high-dielectric-constant solvent is a cyclic compound such as the cyclic carbonic acid ester or the lactone described above. Note that a chain compound such as the chain carbonic acid ester or the chain carboxylic acid ester described above is a low-dielectric-constant solvent having a specific dielectric constant that is smaller than that of the high-dielectric-constant solvent.

In particular, it is more preferable that the high-dielectric-constant solvent include the lactone, and a proportion R of a weight W2 of the lactone to a weight W1 of the high-dielectric-constant solvent be within a range from 30 wt % to 100 wt % both inclusive. A reason for this is that this prevents the discharge capacity from decreasing easily even if the secondary battery including the electrolytic solution is charged and discharged. The proportion R is calculated based on the following calculation expression: proportion R (wt %)=(W2/W1)×100.

The electrolyte salt is a light metal salt such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tri s(trifluoromethanesulfonyl)methide (LiC(CF₃SO₂)₃), and lithium bis(oxalato)borate (LiB(C₂O₄)₂).

A content of the electrolyte salt is not particularly limited, and is within a range from 0.3 mol/kg to 3.0 mol/kg both inclusive with respect to the solvent. A reason for this is that high ion conductivity is obtainable.

Note that the electrolytic solution may further include one or more of additives.

The additive includes an unsaturated cyclic carbonic acid ester, a halogenated cyclic carbonic acid ester, or both. A reason for this is that, in the case where the electrolytic solution is included in the secondary battery, the decomposition reaction of the electrolytic solution is suppressed. A content of each of the unsaturated cyclic carbonic acid ester and the halogenated cyclic carbonic acid ester in the electrolytic solution may be set as desired.

The unsaturated cyclic carbonic acid ester is a cyclic carbonic acid ester having an unsaturated bond (a carbon-carbon double bond). Specific examples of the unsaturated cyclic carbonic acid ester include vinylene carbonate (1,3-dioxol-2-one), vinylethylene carbonate (4-vinyl-1,3-dioxolane-2-one), and methylene ethylene carbonate (4-methylene-1,3-dioxolane-2-one).

The halogenated cyclic carbonic acid ester is a cyclic carbonic acid ester including a halogen as a constituent element, that is, a compound in which one or more hydrogen atoms of a cyclic carbonic acid ester are substituted with one or more halogen groups. The one or more halogen groups are not particularly limited in kind, and are one or more of a fluorine group, a chlorine group, a bromine group, or an iodine group. Specific examples of the halogenated cyclic carbonic acid ester include fluoroethylene carbonate (4-fluoro-1,3-dioxolane-2-one) and difluoroethylene carbonate (4,5-difluoro-1,3-dioxolane-2-one).

Further, the additive includes one or more of a sulfonic acid ester, a sulfuric acid ester, a sulfurous acid ester, a dicarboxylic anhydride, a disulfonic anhydride, or a sulfonic carboxylic anhydride. A reason for this is that, in the case where the electrolytic solution is included in the secondary battery, the decomposition reaction of the electrolytic solution is suppressed. A content of each of the sulfonic acid ester, the sulfuric acid ester, the sulfurous acid ester, the dicarboxylic anhydride, the disulfonic anhydride, and the sulfonic carboxylic anhydride in the electrolytic solution may be set as desired.

Specific examples of the sulfonic acid ester include 1,3-propane sultone, 1-propene-1,3-sultone, 1,4-butane sultone, 2,4-butane sultone, and methanesulfonic acid propargyl ester.

Specific examples of the sulfuric acid ester include 1,3,2-dioxathiolane 2,2-dioxide, 1,3,2-dioxathiane 2,2-dioxide, and 4-methylsulfonyloxymethyl-2,2-dioxo-1,3,2-dioxathiolane.

Specific examples of the sulfurous acid ester include 1,3-propane sultone, 1-propene-1,3-sultone, 1,4-butane sultone, 2,4-butane sultone, and methanesulfonic acid propargyl ester. Specific examples of the sulfurous acid ester include 1,3,2-dioxathiolane 2-oxide and 4-methyl-1,3,2-dioxathiolane 2-oxide.

Specific examples of the dicarboxylic anhydride include 1,4-dioxane-2,6-dione, succinic anhydride, and glutaric anhydride.

Specific examples of the disulfonic anhydride include 1,2-ethanedisulfonic anhydride, 1,3-propanedisulfonic anhydride, and hexafluoro 1,3-propanedisulfonic anhydride.

Specific examples of the sulfonic carboxylic anhydride include 2-sulfobenzoic acid anhydride and 2,2-dioxooxathiolane-5-one.

In addition, another compound is a nitrile compound. A reason for this is that, in the case where the electrolytic solution is included in the secondary battery, the decomposition reaction of the electrolytic solution is suppressed. A content of the nitrile compound in the electrolytic solution may be set as desired.

The nitrile compound is a compound having one or more cyano groups (—CN). Specific examples of the nitrile compound include octanenitrile, benzonitrile, phthalonitrile, succinonitrile, glutaronitrile, adiponitrile, cebaconitrile, 1,3,6-hexanetricarbonitrile, 3,3′-oxydipropionitrile, 3-butoxypropionitrile, ethylene glycol bispropionitrile ether, 1,2,2,3-tetracyanopropane, tetracyanopropane, fumaronitrile, 7,7,8,8-tetracyanoquinodimethane, cyclopentanecarbonitrile, 1,3,5-cyclohexanetricarbonitrile, and 1,3-bis(dicyanomethylidene)indane.

In a case of manufacturing the electrolytic solution, the electrolyte salt is added to the solvent, following which the first unsaturated compound and the second unsaturated compound are added to the solvent. The electrolyte salt, the first unsaturated compound, and the second unsaturated compound are thereby each dispersed or dissolved in the solvent. As a result, the electrolytic solution is prepared.

The electrolytic solution includes both the first unsaturated compound and the second unsaturated compound.

In this case, the durability of the film formed on the surface of the electrode in the secondary battery including the electrolytic solution improves as compared with the case where the electrolytic solution includes only one of the first unsaturated compound or the second unsaturated compound, as described above.

For example, the first unsaturated compound, which is a cyclic compound in which the unsaturated carbon bond (the carbon-carbon double bond) is introduced into the lactone-type ring structure, has a property of forming the film on the surface of the electrode by being decomposed and undergoing reaction upon charging and discharging. Thus, the surface of the electrode is protected by the film if the electrolytic solution includes the first unsaturated compound. Accordingly, the decomposition reaction of the electrolytic solution is suppressed on the surface of the electrode having a reactive property, which prevents the discharge capacity from decreasing easily.

However, a film derived from the first unsaturated compound has a high affinity for the solvent, and thus has low solvent resistance. In this case, it becomes easier for the film derived from the first unsaturated compound to be decomposed if the charging and discharging is repeated, and this causes an amount of film covering the electrode to be decreased easily. Accordingly, upon repeated use of the secondary battery, the decomposition reaction of the electrolytic solution is not sufficiently suppressed, and thus, the discharge capacity is decreased easily.

The same applies to a case where the electrolytic solution includes only the second unsaturated compound. That is, in the case where the electrolytic solution includes only the second unsaturated compound, as with the case where the electrolytic solution includes only the first unsaturated compound, the decomposition reaction of the electrolytic solution is not sufficiently suppressed due to low solvent resistance of a film derived from the second unsaturated compound, and thus, the discharge capacity is decreased easily upon repeated charging and discharging.

In contrast, in a case where the electrolytic solution includes both the first unsaturated compound and the second unsaturated compound, the solvent resistance of the first unsaturated compound improves significantly owing to synergistic interaction between the first unsaturated compound and the second unsaturated compound. This prevents the film derived from the first unsaturated compound from being decomposed easily even upon repeated charging and discharging, which helps to maintain easily the amount of film covering the electrode. Accordingly, the decomposition reaction of the electrolytic solution is sufficiently suppressed even upon repeated charging and discharging, which prevents the discharge capacity from decreasing easily.

Based upon the foregoing, in the case where the electrolytic solution includes both the first unsaturated compound and the second unsaturated compound, the decomposition reaction of the electrolytic solution is sufficiently suppressed as compared with the case where electrolytic solution includes only one of the first unsaturated compound or the second unsaturated compound. This helps to prevent the discharge capacity from decreasing easily even upon repeated charging and discharging. Accordingly, in the secondary battery including the electrolytic solution, it is possible to achieve a superior cyclability characteristic.

In particular, in an embodiment, the first unsaturated compound D may include one or more of the respective compounds represented by Formulae (21) to (24). This sufficiently suppresses the decomposition reaction of the electrolytic solution owing to sufficient improvement in the durability of the film. Accordingly, it is possible to achieve higher effects.

In addition, the content of the first unsaturated compound in the electrolytic solution may be within the range from 0.1 wt % to 2 wt % both inclusive, and the content of the second unsaturated compound in the electrolytic solution may be within the range from 0.01 wt % to 1 wt % both inclusive. This sufficiently suppresses the decomposition reaction of the electrolytic solution owing to sufficient improvement in the durability of the film. Accordingly, it is possible to achieve higher effects.

In addition, the solvent (the high-dielectric-constant solvent) may include the lactone, and the proportion R may be within the range from 30 wt % to 100 wt % both inclusive. This makes it possible to obtain a high discharge capacity even upon repeated charging and discharging, owing to the fact that the high battery capacity is obtainable. Accordingly, it is possible to achieve higher effects.

In addition, the electrolytic solution may further include the unsaturated cyclic carbonic acid ester, the halogenated cyclic carbonic acid ester, or both. This further suppresses the decomposition reaction of the electrolytic solution. Accordingly, it is possible to achieve higher effects.

In addition, the electrolytic solution may further include one or more of the sulfonic acid ester, the sulfuric acid ester, the sulfurous acid ester, the dicarboxylic anhydride, the disulfonic anhydride, or the sulfonic carboxylic anhydride. This further suppresses the decomposition reaction of the electrolytic solution. Accordingly, it is possible to achieve higher effects.

In addition, the electrolytic solution may further include the nitrile compound. This further suppresses the decomposition reaction of the electrolytic solution. Accordingly, it is possible to achieve higher effects.

A description is given next of a secondary battery including the electrolytic solution described herein.

The secondary battery to be described here is a secondary battery that obtains a battery capacity using insertion and extraction of an electrode reactant, and includes a positive electrode, a negative electrode, and an electrolytic solution which is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

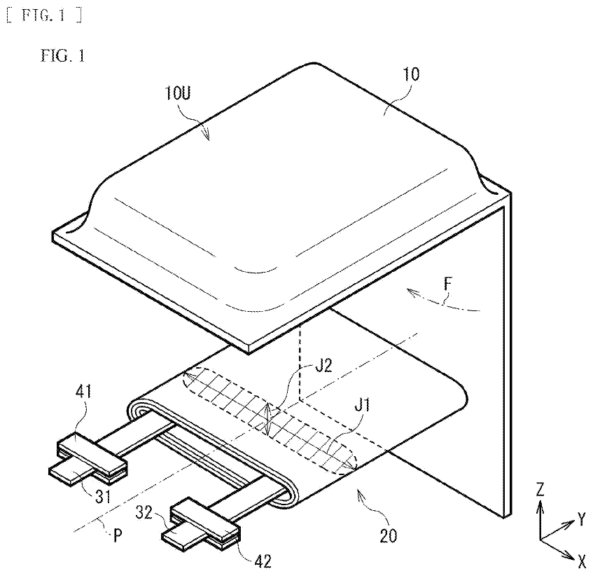

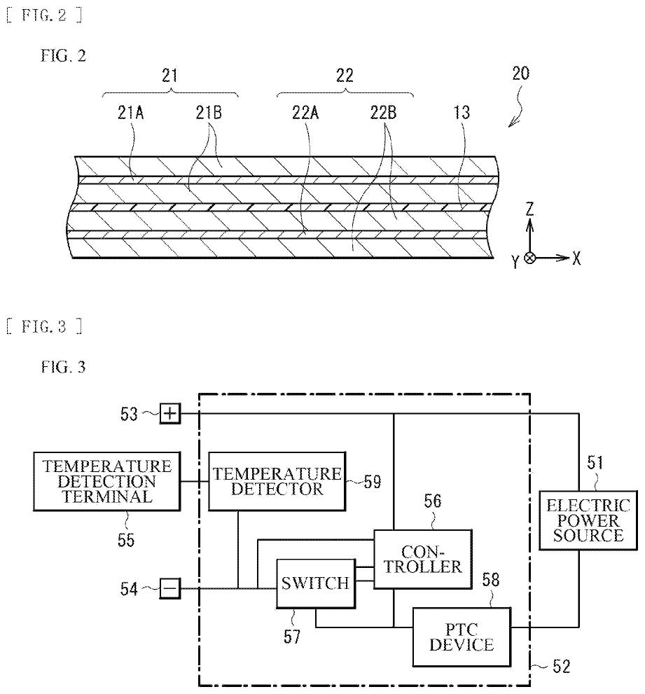

FIG. 1 illustrates a perspective configuration of the secondary battery. FIG. 2 illustrates a sectional configuration of a battery device 20 illustrated in FIG. 1. Note that FIG. 1 illustrates a state in which an outer package film 10 and the battery device 20 are separated from each other, and illustrates a section of the battery device 20 along an XZ plane by a dashed line. FIG. 2 illustrates only a portion of the battery device 20.

As illustrated in FIGS. 1 and 2, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 1, the outer package film 10 is a flexible outer package member that contains the battery device 20. The outer package film 10 has a pouch-shaped structure in which the battery device 20 is sealed in a state of being contained inside the outer package film 10. The outer package film 10 thus contains the positive electrode 21, the negative electrode 22, and an electrolytic solution that are to be described later.

Here, the outer package film 10 is a single film-shaped member and is foldable toward a folding direction F. The outer package film 10 has a depression part 10U to place the battery device 20 therein. The depression part 10U is a so-called deep drawn part.

The outer package film 10 is a three-layered laminated film including a fusion-bonding layer, a metal layer, and a surface protective layer that are stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 1 and 2, the battery device 20 is a power generation device that includes the positive electrode 21, the negative electrode 22, a separator 23, and the electrolytic solution (not illustrated). The battery device 20 is contained inside the outer package film 10.

The battery device 20 is a so-called wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a winding axis P. The winding axis P is a virtual axis extending in a Y-axis direction. Thus, the positive electrode 21 and the negative electrode 22 are opposed to each other with the separator 23 interposed therebetween, and are wound.

A three-dimensional shape of the battery device 20 is not particularly limited. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a larger length than the minor axis J2. The minor axis J2 is a virtual axis that extends in a Z-axis direction intersecting the X-axis direction and has a smaller length than the major axis J1. Here, the battery device 20 has an elongated cylindrical three-dimensional shape. Thus, the section of the battery device 20 has an elongated, generally elliptical shape.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Examples of the metal material include aluminum.

Here, the positive electrode active material layer 21B is provided on each of the two opposed surfaces of the positive electrode current collector 21A. The positive electrode active material layer 21B includes one or more of positive electrode active materials into which lithium is insertable and from which lithium is extractable. Note that the positive electrode active material layer 21B may be provided only on one of the two opposed surfaces of the positive electrode current collector 21A on a side where the positive electrode 21 is opposed to the negative electrode 22. In addition, the positive electrode active material layer 21B may further include, for example, a positive electrode binder and a positive electrode conductor. A method of forming the positive electrode active material layer 21B is not particularly limited, and includes one or more of methods including, without limitation, a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. The one or more other elements are any one or more of elements belonging to groups 2 to 15 in the long period periodic table. The lithium-containing compound is not particularly limited in kind, and is an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 22 includes, as illustrated in FIG. 2, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Examples of the metal material include copper.

Here, the negative electrode active material layer 22B is provided on each of the two opposed surfaces of the negative electrode current collector 22A. The negative electrode active material layer 22B includes one or more of negative electrode active materials into which lithium is insertable and from which lithium is extractable. Note that the negative electrode active material layer 22B may be provided only on one of the two opposed surfaces of the negative electrode current collector 22A on a side where the negative electrode 22 is opposed to the positive electrode 21. In addition, the negative electrode active material layer 22B may further include, for example, a negative electrode binder and a negative electrode conductor. A method of forming the negative electrode active material layer 22B is not particularly limited, and includes one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material, a metal-based material, or both, for example. A reason for this is that a high energy density is obtainable. Examples of the carbon material include graphitizable carbon, non-graphitizable carbon, and graphite (natural graphite and artificial graphite). The term “metal-based material” is a generic term for a material that includes, as one or more constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

As illustrated in FIG. 2, the separator 23 is an insulating porous film interposed between the positive electrode 21 and the negative electrode 22, and allows lithium ions to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution, and the electrolytic solution has the configuration described above. That is, the electrolytic solution includes both the first unsaturated compound and the second unsaturated compound, together with the solvent and the electrolyte salt.

As illustrated in FIG. 1, the positive electrode lead 31 is a positive electrode terminal coupled to the battery device 20 (the positive electrode 21). More specifically, the positive electrode lead 31 is coupled to the positive electrode current collector 21A. The positive electrode lead 31 is led from an inside to an outside of the outer package film 10. The positive electrode lead 31 includes an electrically conductive material such as aluminum. The positive electrode lead 31 is not particularly limited in shape, and has any of shapes including, without limitation, a thin plate shape and a meshed shape.

As illustrated in FIG. 1, the negative electrode lead 32 is a negative electrode terminal coupled to the battery device 20 (the negative electrode 22). More specifically, the negative electrode lead 32 is coupled to the negative electrode current collector 22A. The negative electrode lead 32 is led from the inside to the outside of the outer package film 10. The negative electrode lead 32 includes an electrically conductive material such as copper. Here, the negative electrode lead 32 is led in a direction similar to that in which the positive electrode lead 31 is led out. Note that details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

In a case of manufacturing the secondary battery, the positive electrode 21 and the negative electrode 22 are fabricated, following which the secondary battery is fabricated using the positive electrode 21, the negative electrode 22, and the electrolytic solution, according to a procedure to be described below. Note that the procedure for preparing the electrolytic solution is as described above.

First, a mixture (a positive electrode mixture) in which the positive electrode active material, the positive electrode binder, and the positive electrode conductor are mixed with each other is put into the solvent to thereby prepare a paste positive electrode mixture slurry. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated. The positive electrode active material layers 21B may be compression-molded multiple times. As a result, the positive electrode 21 is fabricated.

The negative electrode 22 is formed by a procedure similar to the fabrication procedure of the positive electrode 21 described above. A mixture (a negative electrode mixture) in which the negative electrode active material, the negative electrode binder, and the negative electrode conductor are mixed with each other is put into the solvent to thereby prepare a paste negative electrode mixture slurry. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. As a result, the negative electrode 22 is fabricated.

First, the positive electrode lead 31 is coupled to the positive electrode 21 (the positive electrode current collector 21A) by a method such as a welding method, and the negative electrode lead 32 is coupled to the negative electrode 22 (the negative electrode current collector 22A) by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body. The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the outer package film 10 (the fusion-bonding layer) opposed to each other are bonded to each other by a method such as a thermal-fusion-bonding method to thereby contain the wound body in the outer package film 10 having the pouch shape.

Lastly, the electrolytic solution is injected into the outer package film 10 having the pouch shape, following which the outer edge parts of the remaining one side of the outer package film 10 (the fusion-bonding layer) are bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. The wound body is thereby impregnated with the electrolytic solution. Thus, the battery device 20 that is a wound electrode body is fabricated, and the battery device 20 is sealed in the outer package film 10 having the pouch shape. As a result, the secondary battery is assembled.

The assembled secondary battery is charged and discharged. Conditions including, for example, an environment temperature, the number of times of charging and discharging (the number of cycles), and charging and discharging conditions may be set as desired. As a result, a film is formed on a surface of each of the positive electrode 21 and the negative electrode 22, which electrochemically stabilizes a state of the secondary battery. As a result, the secondary battery of the laminated-film type including the outer package film 10 is completed.

The secondary battery includes the electrolytic solution described above. In this case, the decomposition reaction of the electrolytic solution is sufficiently suppressed for the reason described above, which prevents the discharge capacity from decreasing easily even upon repeated charging and discharging. It is thus possible to achieve a superior cyclability characteristic.

Further, the secondary battery may include a lithium-ion secondary battery. This makes it possible to obtain a sufficient battery capacity stably through the use of insertion and extraction of lithium. Accordingly, it is possible to achieve higher effects.

Other action and effects of the secondary battery are similar to those of the electrolytic solution described above.

The configuration of the secondary battery described herein is appropriately modifiable including as described below. Note that any two or more of the following series of modifications may be combined with each other.

The separator 23 which is a porous film is used. However, although not illustrated here, a separator of a stacked type including a polymer compound layer may be used instead of the separator 23 which is the porous film.

The separator of the stacked type includes a porous film having two opposed surfaces, and the polymer compound layer disposed on one of or each of the two opposed surfaces of the porous film. A reason for this is that adherence of the separator to each of the positive electrode 21 and the negative electrode 22 improves to suppress the occurrence of misalignment of the battery device 20. This helps to prevent the secondary battery from easily swelling even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

In the case where the separator of the stacked type is used also, lithium ions are movable between the positive electrode 21 and the negative electrode 22, and similar effects are therefore obtainable.

The electrolytic solution which is a liquid electrolyte is used. However, although not illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, following which the stack of the positive electrode 21, the negative electrode 22, the separator 23, and the electrolyte layer is wound. The electrolyte layer is interposed between the positive electrode 21 and the separator 23, and between the negative electrode 22 and the separator 23.

The electrolyte layer includes a polymer compound together with the electrolytic solution. The electrolytic solution is held by the polymer compound. A reason for this is that liquid leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

In a case where the electrolyte layer is used also, lithium ions are movable between the positive electrode 21 and the negative electrode 22 via the electrolyte layer, and similar effects are therefore obtainable.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

An application example of the secondary battery will now be described in further detail according to an embodiment. The configuration of the application example described below is merely an example, and is appropriately modifiable.

FIG. 3 illustrates a block configuration of a battery pack. The battery pack described here is a battery pack (a so-called soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is 4.2 V±0.05 V. The overdischarge detection voltage is not particularly limited, and is 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is given of Examples of the present technology according to an embodiment.

### Experiment Examples 1-1 to 1-37

Secondary batteries were fabricated, following which the secondary batteries were each evaluated for a battery characteristic as described below.

### [Fabrication of Secondary Battery]

The lithium-ion secondary batteries of the laminated-film type illustrated in FIGS. 1 and 2 were fabricated in accordance with the following procedure.

### (Fabrication of Positive Electrode)

First, 91 parts by mass of the positive electrode active material (LiCoO₂ which is the lithium-containing compound (an oxide)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone which is the organic solvent), following which the organic solvent was stirred to thereby prepare a paste positive electrode mixture slurry. Thereafter, the positive electrode mixture slurry was applied on the two opposed surfaces of the positive electrode current collector 21A (a band-shaped aluminum foil having a thickness of 12 μm) by means of a coating apparatus, following which the applied positive electrode mixture slurry was dried to thereby form the positive electrode active material layers 21B. Lastly, the positive electrode active material layers 21B were compression-molded by means of a roll pressing machine. In this manner, the positive electrode 21 was fabricated.

### (Fabrication of Negative Electrode)

First, 93 parts by mass of the negative electrode active material (artificial graphite which is the carbon material) and 7 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone which is the organic solvent), following which the organic solvent was stirred to thereby prepare a paste negative electrode mixture slurry. Thereafter, the negative electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. Lastly, the negative electrode active material layers 22B were compression-molded by means of a roll pressing machine. In this manner, the negative electrode 22 was fabricated.

### (Preparation of Electrolytic Solution)

The electrolyte salt (LiPF₆ which is the lithium salt) was added to the solvent, following which the solvent was stirred. Used as the solvent were γ-butyrolactone (GBL) which is the high-dielectric-constant solvent (the lactone), ethylene carbonate (EC) which is also the high-dielectric-constant solvent (the cyclic carbonic acid ester), and dimethyl carbonate (DMC) which is the low-dielectric-constant solvent (the chain carboxylic acid ester). A mixture ratio (a weight ratio) of the solvent between GBL, EC, and DMC was set to 10:10:80 to thereby set the proportion R (wt %) to 50 wt %. A content of the electrolyte salt was set to 1.2 mol/kg with respect to the solvent. Thereafter, the first unsaturated compound and the second unsaturated compound were added to the solvent to which the electrolyte salt was added, following which the solvent was stirred. As a result, the electrolytic solution was prepared.

A kind of the first unsaturated compound and a content (wt %) of the first unsaturated compound in the electrolytic solution, and a kind of the second unsaturated compound and a content (wt %) of the second unsaturated compound in the electrolytic solution were as presented in Tables 1 and 2.

### (Assembly of Secondary Battery)

First, the positive electrode lead 31 including aluminum was welded to the positive electrode 21 (the positive electrode current collector 21A), and the negative electrode lead 32 including copper was welded to the negative electrode 22 (the negative electrode current collector 22A).

Thereafter, the positive electrode 21 and the negative electrode 22 were stacked on each other with the separator 23 (a fine porous polyethylene film having a thickness of 15 μm) interposed therebetween, following which the stack of the positive electrode 21, the negative electrode 22, and the separator 23 was wound to thereby fabricate a wound body. Thereafter, the wound body was pressed by means of a pressing machine, and was thereby shaped into an elongated shape.

Thereafter, the outer package film 10 was folded in such a manner as to sandwich the wound body contained inside the depression part 10U. As the outer package film 10, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from an inner side. Thereafter, the outer edge parts of two sides of the outer package film 10 (the fusion-bonding layer) were thermal-fusion-bonded to each other to thereby allow the wound body to be contained inside the outer package film 10 having the pouch shape.

Lastly, the electrolytic solution was injected into the outer package film 10 having the pouch shape and thereafter, the outer edge parts of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. In this manner, the wound body was impregnated with the electrolytic solution. As a result, the battery device 20 which is the wound electrode body was fabricated. Accordingly, the battery device 20 was sealed in the outer package film 10. As a result, the secondary battery was assembled.

### (Stabilization of Secondary Battery)

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours. As a result, the secondary battery of the laminated-film type was completed.

### Comparative Examples 1-1 to 1-3

A secondary battery was fabricated by a similar procedure except that neither the first unsaturated compound nor the second unsaturated compound was used, following which the secondary battery was evaluated for a battery characteristic. Further, secondary batteries were fabricated by a similar procedure except that only one of the first unsaturated compound or the second unsaturated compound was used, following which the secondary batteries were each evaluated for a battery characteristic.

### [Evaluation of Battery Characteristic]

Evaluation of the secondary batteries for their battery characteristics (cyclability characteristics) revealed the results presented in Tables 1 and 2.

In a case of examining the cyclability characteristic, first, the secondary battery was charged in a high-temperature environment (at a temperature of 50° C.), following which the charged secondary battery was left standing (for a standing time of 3 hours) in the same environment. Upon charging, the secondary battery was charged with a constant current of 1 C until a voltage reached 4.2 V, and was thereafter charged with a constant voltage of 4.2 V until a current reached 0.05 C. Note that 1 C is a value of a current that causes the battery capacity to be completely discharged in 1 hour.

Thereafter, the secondary battery was discharged in the same environment to thereby measure a discharge capacity (a first-cycle discharge capacity). Upon discharging, the secondary battery was discharged with a constant current of 3 C until a voltage reached 3.0 V. Note that 3 C is a value of a current that causes the battery capacity to be completely discharged in 10/3 hours.

Thereafter, the secondary battery was repeatedly charged and discharged in the same environment until the number of cycles reached 100 to thereby measure the discharge capacity (a 100th-cycle discharge capacity). Charging and discharging conditions of the second to 100th cycles were similar to the charging and discharging conditions of the first cycle.

Lastly, a capacity retention rate which is an index for evaluating the cyclability characteristic was calculated based on the following calculation expression: capacity retention rate (%)=(100th-cycle discharge capacity/first-cycle discharge capacity)×100.

TABLE 1

| | First unsaturated compound | | Second unsaturated compound | | Capacity |
|---|---|---|---|---|---|
| | | Content | | Content | retention |
| | Kind | (wt %) | Kind | (wt %) | rate (%) |
| Example 1-1 | Formula (1-1) | 1.5 | Formula (5-1) | 0.2 | 69 |
| Example 1-2 | Formula (1-2) | 1.5 | Formula (5-1) | | 70 |
| Example 1-3 | Formula (1-3) | 1.5 | Formula (5-1) | | 70 |
| Example 1-4 | Formula (2-1) | 1.5 | Formula (5-1) | | 69 |
| Example 1-5 | Formula (3-1) | 1.5 | Formula (5-1) | | 70 |
| Example 1-6 | Formula (3-2) | 1.5 | Formula (5-1) | | 64 |
| Example 1-7 | Formula (4-1) | 1.5 | Formula (5-1) | | 68 |
| Example 1-8 | Formula (4-2) | 1.5 | Formula (5-1) | | 66 |
| Example 1-9 | Formula (4-3) | 1.5 | Formula (5-1) | | 65 |
| Example 1-10 | Formula (4-4) | 1.5 | Formula (5-1) | | 67 |
| Example 1-11 | Formula (4-5) | 1.5 | Formula (5-1) | | 67 |
| Example 1-12 | Formula (4-6) | 1.5 | Formula (5-1) | | 66 |
| Example 1-13 | Formula (1-1) | 1.5 | Formula (6-1) | 0.2 | 69 |
| Example 1-14 | Formula (1-1) | | Formula (7-1) | 0.2 | 66 |
| Example 1-15 | Formula (1-1) | | Formula (7-2) | 0.2 | 66 |
| Example 1-16 | Formula (1-1) | | Formula (8-1) | 0.2 | 68 |
| Example 1-17 | Formula (1-1) | | Formula (9-1) | 0.2 | 68 |
| Example 1-18 | Formula (1-1) | | Formula (10-1) | 0.2 | 65 |
| Example 1-19 | Formula (1-1) | | Formula (11-1) | 0.2 | 66 |
| Example 1-20 | Formula (1-1) | | Formula (11-2) | 0.2 | 68 |
| Example 1-21 | Formula (1-1) | | Formula (11-3) | 0.2 | 69 |
| Example 1-22 | Formula (1-1) | | Formula (12-1) | 0.2 | 64 |
| Example 1-23 | Formula (1-1) | | Formula (13-1) | 0.2 | 66 |
| Example 1-24 | Formula (1-1) | | Formula (14-1) | 0.2 | 67 |

TABLE 2

| | First unsaturated compound | | Second unsaturated compound | | Capacity |
|---|---|---|---|---|---|
| | | Content | | Content | retention |
| | Kind | (wt %) | Kind | (wt %) | rate (%) |
| Example 1-25 | Formula (1-1) | 1.5 | Formula (15-1) | 0.2 | 65 |
| Example 1-26 | Formula (1-1) | | Formula (15-2) | 0.2 | 64 |
| Example 1-27 | Formula (1-1) | | Formula (15-3) | 0.2 | 65 |
| Example 1-28 | Formula (1-1) | | Formula (16-1) | 0.2 | 68 |
| Example 1-29 | Formula (1-1) | 0.05 | Formula (5-1) | 0.2 | 61 |
| Example 1-30 | Formula (1-1) | 0.1 | Formula (5-1) | | 67 |
| Example 1-31 | Formula (1-1) | 1.0 | Formula (5-1) | | 68 |
| Example 1-32 | Formula (1-1) | 2.0 | Formula (5-1) | | 66 |
| Example 1-33 | Formula (1-1) | 3.0 | Formula (5-1) | | 60 |
| Example 1-34 | Formula (1-1) | 1.5 | Formula (5-1) | 0.005 | 60 |
| Example 1-35 | Formula (1-1) | | Formula (5-1) | 0.01 | 65 |
| Example 1-36 | Formula (1-1) | | Formula (5-1) | 1.0 | 66 |
| Example 1-37 | Formula (1-1) | | Formula (5-1) | 2.0 | 61 |
| Comparative | — | — | — | — | 42 |
| example 1-1 | | | | | |
| Comparative | Formula (1-1) | 1.5 | — | — | 50 |
| example 1-2 | | | | | |
| Comparative | — | — | Formula (5-1) | 0.2 | 48 |
| example 1-3 | | | | | |

As indicated in Tables 1 and 2, the capacity retention rate varied greatly depending on the composition of the electrolytic solution. In the following, the capacity retention rate in a case where the electrolytic solution included neither the first unsaturated compound nor the second unsaturated compound (Comparative example 1-1) is set as a comparison reference.

In a case where the electrolytic solution included only the first unsaturated compound (Comparative example 1-2), the capacity retention rate increased, and in a case where the electrolytic solution included only the second unsaturated compound (Comparative example 1-3), the capacity retention rate increased.

More specifically, in the case where the electrolytic solution included only the first unsaturated compound, the capacity retention rate increased by approximately 19%, and in the case where the electrolytic solution included only the second unsaturated compound, the capacity retention rate increased by approximately 14%. Accordingly, it is expectable that in the case where the electrolytic solution includes both the first unsaturated compound and the second unsaturated compound, the capacity retention rate is to be increased by approximately 33% (=19%+14%).

However, in practice, the capacity retention rate increased significantly in the case where the electrolytic solution included both the first unsaturated compound and the second unsaturated compound (Examples 1-1 to 1-37).

More specifically, in the case where the electrolytic solution included both the first unsaturated compound and the second unsaturated compound, the capacity retention rate increased by a range from approximately 52% to approximately 67% both inclusive. Against the above-described expectation, an increase rate (=the range from approximately 52% to approximately 67% both inclusive) of the capacity retention rate was almost twice as high as the expected value (=approximately 33%). It is considered that a reason why the capacity retention rate increased significantly in the case where the electrolytic solution included both the first unsaturated compound and the second unsaturated compound is that the decomposition reaction of the electrolytic solution was markedly suppressed owing to the synergistic interaction between the first unsaturated compound and the second unsaturated compound.

In particular, in the case where the electrolytic solution included both the first unsaturated compound and the second unsaturated compound, the capacity retention rate increased sufficiently if the content of the first unsaturated compound in the electrolytic solution was within the range from 0.1 wt % to 2 wt % both inclusive and the content of the second unsaturated compound in the electrolytic solution was within the range from 0.01 wt % to 1 wt % both inclusive.

### Examples 2-1 to 2-4

As indicated in Table 3, secondary batteries were fabricated by a similar procedure except that each of the unsaturated cyclic carbonic acid ester and the halogenated cyclic carbonic acid ester was included as the additive in the electrolytic solution, following which the secondary batteries were each evaluated for a battery characteristic.

A kind of the unsaturated cyclic carbonic acid ester and a content (wt %) of the unsaturated cyclic carbonic acid ester in the electrolytic solution, and a kind of the halogenated cyclic carbonic acid ester and a content (wt %) of the halogenated cyclic carbonic acid ester in the electrolytic solution were as presented in Table 3. Here, vinylene carbonate (VC) was used as the unsaturated cyclic carbonic acid ester, and fluoroethylene carbonate (FEC) was used as the halogenated cyclic carbonic acid ester.

TABLE 3
Content of first unsaturated compound = 1.5 wt %, content of
second unsaturated compound = 0.2 wt %

| | First | Second | | | | |
|---|---|---|---|---|---|---|
| | unsaturated | unsaturated | Additive | | | Capacity |
| | compound | compound | | | Content | retention |
| | Kind | Kind | Type | Kind | (wt %) | rate (%) |
| Example | Formula | Formula | Unsaturated | VC | 1 | 75 |
| 2-1 | (1-1) | (5-1) | cyclic | | | |
| Example | | | carbonic | | 5 | 76 |
| 2-2 | | | acid ester | | | |
| Example | | | Halogenated | FEC | 1 | 76 |
| 2-3 | | | cyclic | | | |
| Example | | | carbonic | | 5 | 78 |
| 2-4 | | | acid ester | | | |

As indicated in Table 3, in the case where the electrolytic solution included each of the unsaturated cyclic carbonic acid ester and the halogenated cyclic carbonic acid ester (Examples 2-1 to 2-4), the capacity retention rate further increased.

### Examples 3-1 to 3-18

As indicated in Tables 4 and 5, secondary batteries were fabricated by a similar procedure except that each of the sulfonic acid ester, the sulfuric acid ester, the sulfurous acid ester, the dicarboxylic anhydride, the disulfonic anhydride, and the sulfonic carboxylic anhydride was included as the additive in the electrolytic solution, following which the secondary batteries were each evaluated for a battery characteristic.

A kind of the sulfonic acid ester and a content (wt %) of the sulfonic acid ester in the electrolytic solution, a kind of the sulfuric acid ester and a content (wt %) of the sulfuric acid ester in the electrolytic solution, a kind of the sulfurous acid ester and a content (wt %) of the sulfurous acid ester in the electrolytic solution, a kind of the dicarboxylic anhydride and a content (wt %) of the dicarboxylic anhydride in the electrolytic solution, a kind of the disulfonic anhydride and a content (wt %) of the disulfonic anhydride in the electrolytic solution, and a kind of the sulfonic carboxylic anhydride and a content (wt %) of the sulfonic carboxylic anhydride in the electrolytic solution were as presented in Tables 4 and 5.

Here, used as the sulfonic acid ester were 1,3-propane sultone (PS), 1-propene-1,3-sultone (PRS), 1,4-butane sultone (BS1), 2,4-butane sultone (BS2), and methanesulfonic acid propargyl ester (MSP).

Used as the sulfuric acid ester were 1,3,2-dioxathiolane 2,2-dioxide (OTO), 1,3,2-dioxathiane 2,2-dioxide (OTA), and 4-methylsulfonyloxymethyl-2,2-dioxo-1,3,2-dioxathiolane (SOTO).

Used as the sulfurous acid ester were 1,3,2-dioxathiolane 2-oxide (DTO) and 4-methyl-1,3,2-dioxathiolane 2-oxide (MDTO).

Used as the dicarboxylic anhydride were 1,4-dioxane-2,6-dione (DOD), succinic anhydride (SA), and glutaric anhydride (GA).

Used as the disulfonic anhydride were 1,2-ethanedisulfonic anhydride (ESA), 1,3-propanedidisulfonic anhydride (PSA), and hexafluoro 1,3-propanedisulfonic anhydride (FPSA).

Used as the sulfonic carboxylic anhydride were 2-sulfobenzoic acid anhydride (SBA) and 2,2-dioxooxathiolane-5-one (DOTO).

TABLE 4
Content of first unsaturated compound =1.5 wt %, content of
second unsaturated compound = 0.2 wt %

| | First | Second | | | | |
|---|---|---|---|---|---|---|
| | unsaturated | unsaturated | Additive | | | Capacity |
| | compound | compound | | | Content | retention |
| | Kind | Kind | Type | Kind | (wt %) | rate (%) |
| Example | Formula | Formula | Sulfonic | PS | 1.0 | 76 |
| 3-1 | (1-1) | (5-1) | acid | | | |
| Example 3-2 | | | ester | PRS | 1.0 | 74 |
| Example 3-3 | | | | BS1 | 1.0 | 73 |
| Example 3-4 | | | | BS2 | 1.0 | 73 |
| Example 3-5 | | | | MSP | 1.0 | 77 |
| Example | | | Sulfuric | OTO | 1.0 | 75 |
| 3-6 | | | acid | | | |
| Example | | | ester | OTA | 1.0 | 74 |
| 3-7 | | | | | | |
| Example | | | | SOTO | 1.0 | 75 |
| 3-8 | | | | | | |
| Example | | | Sulfurous | DTO | 1.0 | 76 |
| 3-9 | | | acid | | | |
| Example | | | ester | MDTO | 1.0 | 75 |
| 3-10 | | | | | | |

TABLE 5
Content of first unsaturated compound = 1.5 wt %, content
of second unsaturated compound = 0.2 wt %

| | First | Second | | | | |
|---|---|---|---|---|---|---|
| | unsaturated | unsaturated | Additive | | | Capacity |
| | compound | compound | | | Content | retention |
| | Kind | Kind | Type | Kind | (wt %) | rate (%) |
| Example | Formula | Formula | Di- | DOD | 1.0 | 73 |
| 3-11 | (1-1) | (5-1) | carboxylic | | | |
| Example | | | anhydride | SA | 1.0 | 73 |
| 3-12 | | | | | | |
| Example 3-13 | | | | GA | 1.0 | 74 |
| Example | | | Disulfonic | ESA | 1.0 | 78 |
| 3-14 | | | anhydride | | | |
| Example | | | | PSA | 1.0 | 79 |
| 3-15 | | | | | | |
| Example | | | | FPSA | 1.0 | 75 |
| 3-16 | | | | | | |
| Example | | | Sulfonic | SBA | 1.0 | 75 |
| 3-17 | | | carboxylic | | | |
| Example 3-18 | | | anhydride | DOTO | 1.0 | 76 |

As indicated in Tables 4 and 5, the capacity retention rate further increased in the case where the electrolytic solution included each of the sulfonic acid ester, the sulfuric acid ester, the sulfurous acid ester, the dicarboxylic anhydride, the disulfonic anhydride, and the sulfonic carboxylic anhydride (Examples 3-1 to 3-18).

### Examples 4-1 to 4-18

As indicated in Table 6, secondary batteries were fabricated by a similar procedure except that the nitrile compound was included as the additive in the electrolytic solution, following which the secondary batteries were each evaluated for a battery characteristic.

A kind of the nitrile compound and a content (wt %) of the nitrile compound in the electrolytic solution were as presented in Table 6. Here, used as the nitrile compound were octanenitrile (ON), benzonitrile (BN), phthalonitrile (PN), succinonitrile (SN), glutaronitrile (GN), adiponitrile (AN), cebaconitrile (SBN), 1,3,6-hexanetricarbonitrile (HCN), 3,3′-oxydipropionitrile (OPN), 3-butoxypropionitrile (BPN), ethylene glycol bispropionitrile ether (EGPN), 1,2,2,3-tetracyanopropane (TCP), tetracyanoethylene (TCE), fumaronitrile (FN), 7,7,8,8-tetracyanoquinodim ethane (TCQ), cyclopentanecarbonitrile (CPCN), 1,3,5-cyclohexanetricarbonitrile (CHCN), and 1,3-bis(dicyanomethylidene)indane (BCMI).

TABLE 6
Content of first unsaturated compound = 1.5 wt %, content
of second unsaturated compound = 0.2 wt %

| | First | Second | | | | |
|---|---|---|---|---|---|---|
| | unsaturated | unsaturated | Additive | | | Capacity |
| | compound | compound | | | Content | retention |
| | Kind | Kind | Type | Kind | (wt %) | rate (%) |
| Example | Formula | Formula | Nitrile | ON | 0.5 | 75 |
| 4-1 | (1-1) | (5-1) | compound | | | |
| Example 4-2 | | | | BN | 0.5 | 74 |
| Example 4-3 | | | | PN | 0.5 | 73 |
| Example 4-4 | | | | SN | 0.5 | 74 |
| Example 4-5 | | | | GN | 0.5 | 73 |
| Example 4-6 | | | | AN | 0.5 | 72 |
| Example 4-7 | | | | SBN | 0.5 | 75 |
| Example 4-8 | | | | HCN | 0.5 | 75 |
| Example 4-9 | | | | OPN | 0.5 | 73 |
| Example 4-10 | | | | BPN | 0.5 | 72 |
| Example 4-11 | | | | EGPN | 0.5 | 74 |
| Example 4-12 | | | | TCP | 0.5 | 73 |
| Example 4-13 | | | | TCE | 0.5 | 72 |
| Example 4-14 | | | | FN | 0.5 | 72 |
| Example 4-15 | | | | TCQ | 0.5 | 73 |
| Example 4-16 | | | | CPCN | 0.5 | 75 |
| Example 4-17 | | | | CHCN | 0.5 | 74 |
| Example 4-18 | | | | BCMI | 0.5 | 72 |

As indicated in Table 6, in the case where the electrolytic solution included the nitrile compound (Examples 4-1 to 4-18), the capacity retention rate further increased.

### Examples 5-1 to 5-15

As indicated in Table 7, secondary batteries were fabricated by a similar procedure except that the composition of the solvent was varied, following which the secondary batteries were each evaluated for a battery characteristic.

A kind of the solvent, a mixture ratio (a content (wt %)) between the solvents, and the proportion R (wt %) were as presented in Table 7. Here, additionally used were: propylene carbonate (PC) as the high-dielectric-constant solvent (the cyclic carbonic acid ester); each of ethylmethyl carbonate (EMC) and diethyl carbonate (DEC) which is the low-dielectric-constant solvent (the chain carbonic acid ester); and propyl propionate (PrPr) which is the low-dielectric-constant solvent (the chain carboxylic acid ester). In this case, the kind of the solvent and the mixture ratio between the solvents were each varied to thereby vary the proportion R.

Here, not only the cyclability characteristic (the capacity retention rate) but also an additional charge and discharge characteristic was evaluated as a battery characteristic.

In a case of examining the additional charge and discharge characteristic, first, the secondary battery was repeatedly charged and discharged by a procedure similar to the procedure for examining the cyclability characteristic described above to thereby measure the 100th-cycle discharge capacity.

Thereafter, the secondary battery was charged in the same environment (at a temperature of 50° C.), following which the charged secondary battery was left standing (for a standing time of 3 hours). Charging conditions were similar to the charging and discharging conditions of the first cycle. Thereafter, the charged secondary battery was left standing (for a standing time of 3 hours) in a low-temperature environment (at a temperature of −20° C.) to thereby sufficiently cool the charged secondary battery through an inside thereof.

Thereafter, the secondary battery was discharged in the same environment (at a temperature of −20° C.) to thereby measure the discharge capacity (a 101st-cycle discharge capacity). Discharge conditions were similar to the discharge conditions of the first cycle.

Lastly, an additional retention rate which is an index for evaluating the additional charge and discharge characteristic was calculated based on the following calculation expression: additional retention rate (%)=(101st-cycle discharge capacity/100th-cycle discharge capacity)×100.

TABLE 7
Content of first unsaturated compound (Formula (1-1)) = 1.5 wt %,
content of second unsaturated compound (Formula (5-1)) = 0.2 wt %

| | | | Cyclic carbonic | | Chain carbonic | | Chain carboxylic | | | | |
|---|---|---|---|---|---|---|---|---|---|---|---|
| | Lactone | | acid ester | | acid ester | | acid ester | | | Capacity | Additional |
| | | Content | | Content | | Content | | Content | Proportion | retention | retention |
| | Kind | (wt %) | Kind | (wt %) | Kind | (wt %) | Kind | (wt %) | R (wt %) | rate (%) | rate (%) |
| Example 1-1 | GBL | 10 | EC | 10 | DMC | 80 | — | — | 50 | 69 | 98 |
| Example 5-1 | — | — | EC | 20 | DMC | 80 | — | — | 0 | 71 | 94 |
| Example 5-2 | GBL | 4 | EC | 16 | DMC | 80 | — | — | 20 | 70 | 95 |
| Example 5-3 | GBL | 6 | EC | 14 | DMC | 80 | — | — | 30 | 70 | 97 |
| Example 5-4 | GBL | 20 | — | — | DMC | 80 | — | — | 100 | 67 | 98 |
| Example 5-5 | GBL | 15 | EC | 15 | EMC + DEC | 35 + 35 | — | — | 50 | 68 | 98 |
| Example 5-6 | GBL | 15 | EC | 15 | DEC | 35 | PrPr | 35 | 50 | 67 | 97 |
| Example 5-7 | — | — | EC | 30 | EMC + DEC | 35 + 35 | — | — | 0 | 70 | 94 |
| Example 5-8 | GBL | 6 | EC | 24 | EMC + DEC | 35 + 35 | — | — | 20 | 70 | 95 |
| Example 5-9 | GBL | 9 | EC | 21 | EMC + DEC | 35 + 35 | — | — | 30 | 69 | 97 |
| Example 5-10 | GBL | 30 | — | — | EMC + DEC | 35 + 35 | — | — | 100 | 68 | 98 |
| Example 5-11 | GBL | 40 | — | — | EMC + DEC | 20 + 20 | PrPr | 20 | 100 | 67 | 98 |
| Example 5-12 | — | — | EC + PC | 20 + 20 | EMC + DEC | 20 + 20 | PrPr | 20 | 0 | 69 | 94 |
| Example 5-13 | GBL | 20 | EC + PC | 10 + 10 | EMC + DEC | 20 + 20 | PrPr | 20 | 50 | 67 | 97 |
| Example 5-14 | — | — | EC + PC | 50 + 50 | — | — | — | — | 0 | 70 | 93 |
| Example 5-15 | GBL | 30 | EC + PC | 35 + 35 | — | — | — | — | 30 | 68 | 98 |

As indicated in Table 7, results similar to those of Table 1 were obtained even if the composition of the solvent were varied. In other words, in the case where the electrolytic solution included both the first unsaturated compound and the second unsaturated compound, the capacity retention rate increased. In this case, the additional retention rate also increased in a case where the proportion R was within a range from 30% to 100% both inclusive (for example, Example 1-1), in particular.

Based upon the results presented in Tables 1 to 7, in the case where the electrolytic solution included both the first unsaturated compound and the second unsaturated compound, a high capacity retention rate was obtained. The secondary battery therefore achieved a superior cyclability characteristic.

Although the present technology has been described above with reference to one or more embodiments including Examples, the configuration of the present technology is not limited to those described herein, and is therefore modifiable in a variety of suitable ways.

The description has been given of the case where the secondary battery has a battery structure of the laminated-film type. However, the battery structure of the secondary battery is not particularly limited. The battery structure may be, for example, a cylindrical type, a prismatic type, a coin type, or a button type.

Further, the description has been given of the case where the battery device has a device structure of a wound type. However, the device structure of the battery device is not particularly limited. The device structure may be, for example, a stacked type in which the electrodes (the positive electrode and the negative electrode) are stacked on each other, or a zigzag folded type in which the electrodes (the positive electrode and the negative electrode) are folded in a zigzag manner.

Further, although the description has been given of the case where the electrode reactant is lithium, the electrode reactant is not particularly limited in kind. The electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

1. A secondary battery comprising:
a positive electrode;
a negative electrode; and
an electrolytic solution including a solvent, an electrolyte salt, a first unsaturated compound, and a second unsaturated compound, the first unsaturated compound including at least one of respective compounds represented by Formulae (1) to (4), the second unsaturated compound including at least one of respective compounds represented by Formulae (5) to (19), 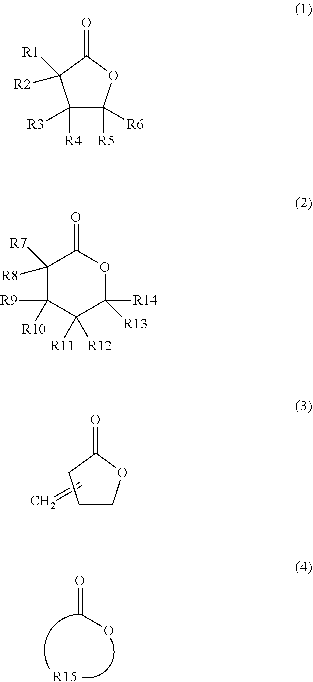
where
each of R1 to R6 is one of hydrogen (H), an alkyl group, an acrylic acid group, or a methacrylic acid group, and at least one of R1 to R6 is one of the acrylic acid group or the methacrylic acid group,
each of R7 to R14 is one of hydrogen (H), an alkyl group, an acrylic acid group, or a methacrylic acid group, and at least one of R7 to R14 is one of the acrylic acid group or the methacrylic acid group, and
R15 is an alkenylene group, 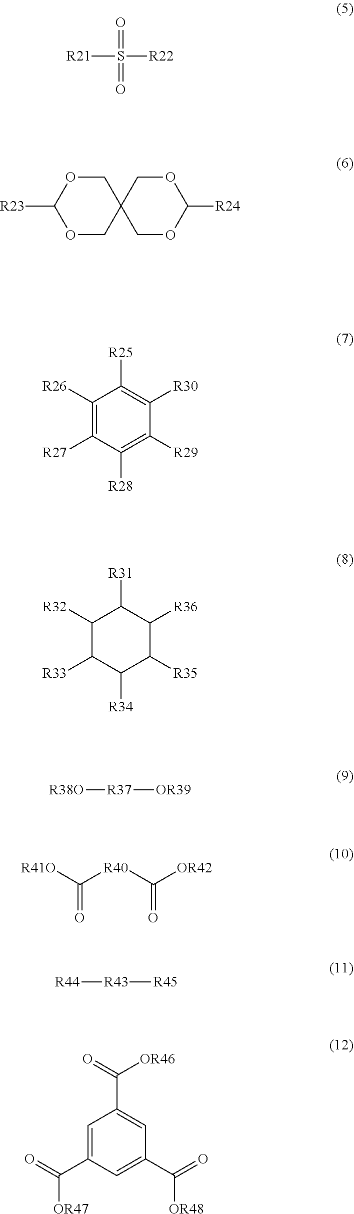 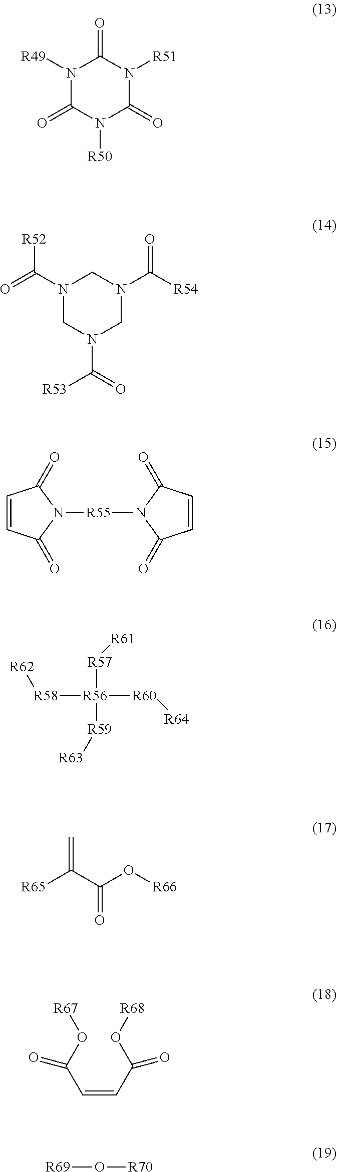
where
each of R21 and R22 is an alkenyl group,
each of R23 and R24 is an alkenyl group,
each of R25 to R30 is one of hydrogen (H) or an alkenyl group, and two or more of R25 to R30 are each the alkenyl group,
each of R31 to R36 is one of hydrogen (H) or an alkenyl group, and two or more of R31 to R36 are each the alkenyl group,
R37 is an alkylene group having an ether bond,
each of R38 and R39 is an alkenyl group,
R40 is an alkylene group,
each of R41 and R42 is an alkenyl group,
R43 is one of an alkylene group, or an alkylene group having an ether bond,
each of R44 and R45 is one of an acrylic acid group or a methacrylic acid group,
each of R46 to R48 is an alkenyl group,
each of R49 to R51 is one of an alkyl group or an alkenyl group, and two or more of R49 to R51 are each the alkenyl group,
each of R52 to R54 is an alkenyl group,
R55 is one of an alkylene group or an arylene group,
R56 is a tetravalent hydrocarbon group,
each of R57 to R60 is an alkylene group,
each of R61 to R64 is one of a hydroxyl group, an acrylic acid group, or a methacrylic acid group, and two or more of R61 to R64 are each one of the acrylic acid group or the methacrylic acid group,
R65 is one of hydrogen (H) or an alkyl group,
R66 is an alkenyl group,
each of R67 and R68 is an alkenyl group, and
each of R69 and R70 is an alkenyl group.

2. The secondary battery according to claim 1, wherein the compound represented by Formula (4) includes at least one of respective compounds represented by Formulae (21) to (24), 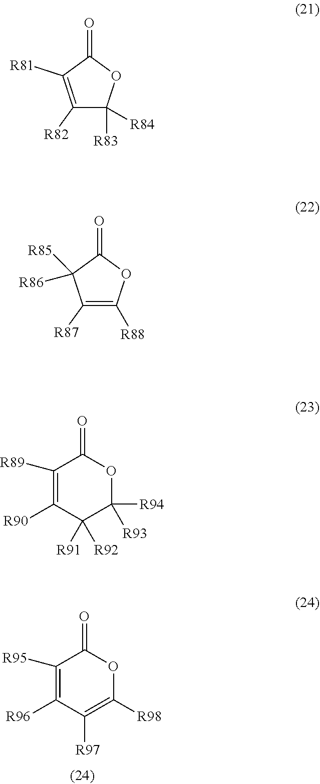
where each of R81 to R98 is one of hydrogen (H) or an alkyl group.

3. The secondary battery according to claim 1, wherein
a content of the first unsaturated compound in the electrolytic solution is greater than or equal to 0.1 weight percent and less than or equal to 2 weight percent, and
a content of the second unsaturated compound in the electrolytic solution is greater than or equal to 0.01 weight percent and less than or equal to 1 weight percent.

4. The secondary battery according to claim 1, wherein
the solvent includes a high-dielectric-constant solvent having a specific dielectric constant of greater than or equal to 20 at a temperature within a range of higher than or equal to −30 degrees Celsius and lower than 60 degrees Celsius,
the high-dielectric-constant solvent includes a lactone, and
a proportion of a weight of the lactone to a weight of the high-dielectric-constant solvent is greater than or equal to 30 weight percent and less than or equal to 100 weight percent.

5. The secondary battery according to claim 1, wherein the electrolytic solution further includes an unsaturated cyclic carbonic acid ester, a halogenated cyclic carbonic acid ester, or both.

6. The secondary battery according to claim 1, wherein the electrolytic solution further includes at least one of a sulfonic acid ester, a sulfuric acid ester, a sulfurous acid ester, a dicarboxylic anhydride, a disulfonic anhydride, or a sulfonic carboxylic anhydride.

7. The secondary battery according to claim 1, wherein the electrolytic solution further includes a nitrile compound.

8. The secondary battery according to claim 1, wherein the secondary battery comprises a lithium-ion secondary battery.

9. An electrolytic solution for a secondary battery, the electrolytic solution comprising:
a solvent;
an electrolyte salt;
a first unsaturated compound including at least one of respective compounds represented by Formulae (1) to (4); and
a second unsaturated compound including at least one of respective compounds represented by Formulae (5) to (19), 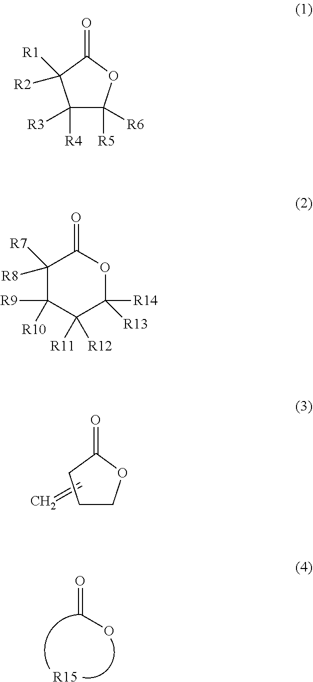
where
each of R1 to R6 is one of hydrogen (H), an alkyl group, an acrylic acid group, or a methacrylic acid group, and at least one of R1 to R6 is one of the acrylic acid group or the methacrylic acid group,
each of R7 to R14 is one of hydrogen (H), an alkyl group, an acrylic acid group, or a methacrylic acid group, and at least one of R7 to R14 is one of the acrylic acid group or the methacrylic acid group, and
R15 is an alkenylene group, 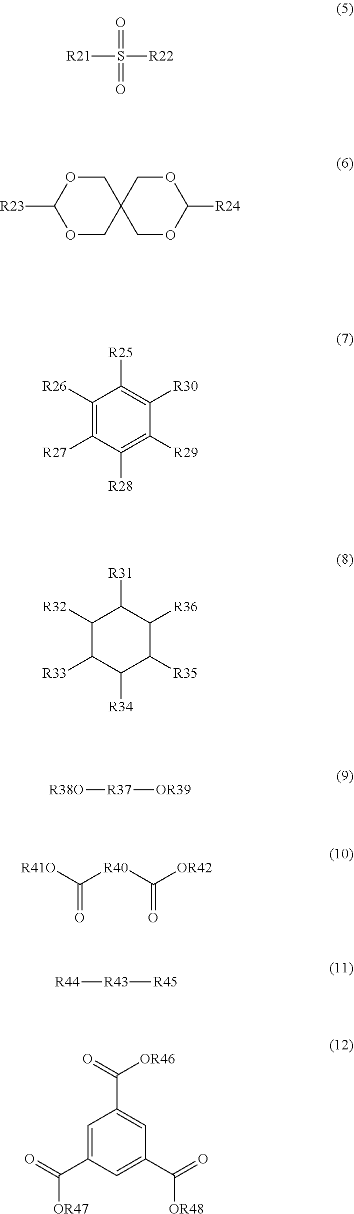 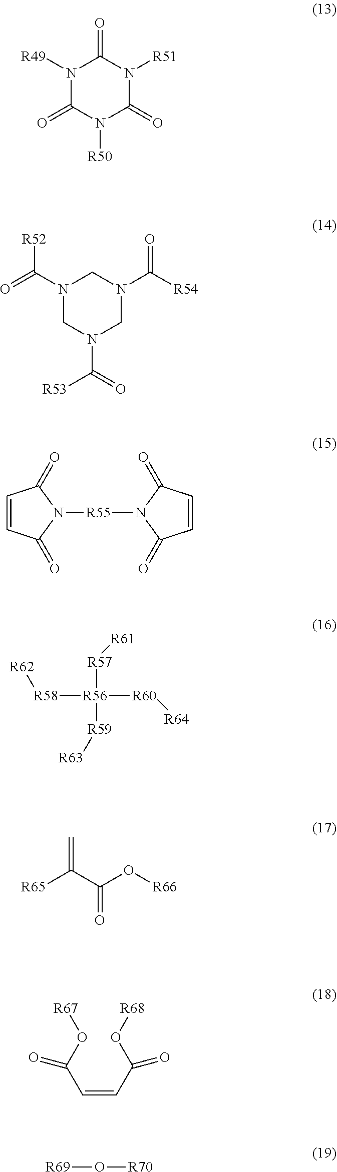
where
each of R21 and R22 is an alkenyl group,
each of R23 and R24 is an alkenyl group,
each of R25 to R30 is one of hydrogen (H) or an alkenyl group, and two or more of R25 to R30 are each the alkenyl group,
each of R31 to R36 is one of hydrogen (H) or an alkenyl group, and two or more of R31 to R36 are each the alkenyl group,
R37 is an alkylene group having an ether bond,
each of R38 and R39 is an alkenyl group,
R40 is an alkylene group,
each of R41 and R42 is an alkenyl group,
R43 is one of an alkylene group, or an alkylene group having an ether bond,
each of R44 and R45 is one of an acrylic acid group or a methacrylic acid group,
each of R46 to R48 is an alkenyl group,
each of R49 to R51 is one of an alkyl group or an alkenyl group, and two or more of R49 to R51 are each the alkenyl group,
each of R52 to R54 is an alkenyl group,
R55 is one of an alkylene group or an arylene group,
R56 is a tetravalent hydrocarbon group,
each of R57 to R60 is an alkylene group,
each of R61 to R64 is one of a hydroxyl group, an acrylic acid group, or a methacrylic acid group, and two or more of R61 to R64 are each one of the acrylic acid group or the methacrylic acid group,
R65 is one of hydrogen (H) or an alkyl group,
R66 is an alkenyl group,
each of R67 and R68 is an alkenyl group, and
each of R69 and R70 is an alkenyl group.
